(19) United States
(12) Patent Application Publication
(10) Pub. No.: US 2007/0081186 A1
(43) Pub. Date: Apr. 12, 2007

(54) IMAGE FORMING APPARATUS AND METHOD FOR CONTROLLING IMAGE FORMING APPARATUS

(75) Inventor: Masahito Numata, Tokyo (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 11/532,448

(22) Filed: Sep. 15, 2006

(30) Foreign Application Priority Data
Oct. 12, 2005 (JP) 2005-297439

(51) Int. Cl. G06F 3/12

(52) U.S. Cl. 358/1.15; 358/1.13

(57) ABSTRACT

An image forming apparatus, for forming an image on recording material based on an input print job, includes an input unit adapted to receive user information for a second user while a first user is logged in with the image forming apparatus, and a processing unit adapted to perform, while the first user is logged in with the image forming apparatus, as a process for a print job related to the second user, whose user information has been received by the input unit, a preprocess that does not accompany image forming.

### BACKGROUND OF THE INVENTION

1. Field of the Invention

The present invention relates to an image forming apparatus for which a process using the image forming apparatus can be reserved, and a control method therefor.

2. Description of the Related Art

A pull print system may be provided in an environment wherein an image forming apparatus, such as an MFP, an information terminal apparatus, such as a PC that serves as a client, and an information processing apparatus, such as a server, are connected via a network. Note that MFP is the acronym for Multi-Function Peripheral, and that PC is the acronym for Personal Computer.

According to pull print systems, the PC can be used to submit an advance registration of a print job with the server, and through manipulation of the operating panel of the MFP, the registered print job can be selected, downloaded and printed.

However, in conventional pull print systems, when a user who desires to use the MFP for pull printing finds that another preceding user is employing the operating panel of the MFP, the user seeking to perform a printing operation may be required to wait until the operation being performed for the preceding user has been completed.

Further, a pull printing process typically requires a time period for the conversion, into PDL data, of a print job having an intermediate file form, such as a PDF file. Other time periods required for carrying out a pull printing process may include the downloading of PDL data from the server to the MFP, the development of PDL raster image data and the actual performance of printing. Here it should be noted that PDF is the acronym for Portable Document Format, and that PDL is the acronym for Page Description Language.

Typically, in conventional pull print systems, when the process being performed by the preceding user has been completed and the operating panel is no longer in use, only then can the next user log in, using the MFP, and start the printing process. Thus, to perform printing, the subsequent user may be required to wait at the MFP for an extended period of time.

In Japanese Patent Laid-Open Application No. 2004-133672, a relevant technique is proposed whereby, for the registration of a PC with a server, a user registering a print job designates a printing reservation date and time, and when the printing reservation date and time has been reached, the printer downloads the print job and image forming is performed. That is, in Japanese Patent Laid-Open Application No. 2004-133672, an image forming apparatus is proposed for which pull printing is performed in accordance with a designated date and time.

Furthermore, in Japanese Patent Laid-Open Application No. 2004-133672, a technique is proposed whereby an image forming apparatus downloads a print job prior to a printing reservation date and time, and when the printing reservation date and time has been reached, image forming is immediately initiated.

Further, in Japanese Patent Laid-Open Application No. 2002-202861, an image forming apparatus is proposed that performs an output data process and an external resource prefetch process at the same time. For example, when an external resource reference command is present in print data received from a computer, the image forming apparatus obtains this external resource, and at the same time, performs the output data process.

However, according to all of the above conventional techniques, during a pull printing process for which a login (user authentication) is required for an image forming apparatus, for example, when a user has already logged in (is currently employing the operating unit), a pull print instruction for the operating unit cannot be entered by another user.

That is, while a preceding user is employing the image forming apparatus, another user who desires to enter a pull print instruction must wait until the operation being performed for the preceding user has been completed. And only then, after the completion of the operation for which the preceding user is employing the operating unit, can the next user log in with the image forming apparatus. Thereafter, of course, the image forming apparatus downloads a print job from the server and performs PDL development, but because of the processing required in this instance, the waiting period for the next user is extended.

### SUMMARY OF THE INVENTION

To resolve or at least mitigate the above shortcomings, embodiments of the present invention are provided wherein a reservation made by a user to employ an image forming apparatus, for performing a printing process, will be accepted, even though another user is currently logged in with the image forming apparatus. Further, during the login of a user, a preprocess (e.g., a downloading or development process for print data for a pull print process for a predetermined process is performed for the user making a reservation so that the waiting time can be reduced for the user.

According to a first aspect of the present invention, at least one embodiment is directed to an image forming apparatus, for forming an image on recording material based on an input print job. The image forming apparatus includes an input unit adapted to receive user information for a second user, who is different from a first user, while the first user is logged in with the image forming apparatus. The image forming apparatus further includes a preprocessing unit adapted to perform, while the first user is logged in with the image forming apparatus, as a process for a print job related to the second user, whose user information has been received by the input unit, a preprocess that does not accompany image forming.

According to a second aspect of the present invention, at least one embodiment is directed to an image forming apparatus, which instructs, through an operating unit, pull printing for a print job that is registered at a predetermined recording location and performs image forming for the print job for which pull printing is instructed. The image forming apparatus includes: an input unit adapted to receive user information; a reserving unit adapted to reserve a pull printing process for a user specified by the user information received by the input unit; a preprocessing unit adapted to perform a preprocess, which does not accompany image forming, for a pull printing process for the print job registered at the predetermined recording location, which is specified based on the user information for the user, that is reserved by the reserving unit; a re-input unit adapted to accept, in asynchronization with the preprocess, entry of user authentication information for authenticating the user, that is reserved by the reserving unit; and a post-processing unit adapted to perform, beginning with remaining process following the performance of the preprocess by the preprocessing unit, the pull printing process for the print job specified by the user authentication information received by the re-input unit.

Other features, objects and advantage of the present invention will be apparent from the following description when taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a system configuration diagram showing the general configuration of a pull print system according to a first embodiment of the present invention;

FIG. 2 is a diagram showing a print job registration screen displayed on the monitor of a client PC in FIG. 1 when the client PC registers a print job with a server according to an embodiment of the present invention;

FIG. 3 is a diagram showing an example data structure for print job information registered with the server shown in FIG. 1 according to an embodiment of the present invention;

FIG. 4 is a plan view of the arrangement of the display unit and the operating unit of the image forming apparatus shown in FIG. 1 according to an exemplary embodiment;

FIG. 5 is a plan view illustrating an operating screen used to request a pull printing reservation at the image forming apparatus while the image forming apparatus is being employed by a preceding user according to an exemplary embodiment;

FIG. 6 is a diagram showing the data structure of reservation information stored in the reservation information holding unit of the image forming apparatus, when a pull print reservation is made, according to an exemplary embodiment;

FIG. 7A is a diagram showing a selection condition for a job to be preprocessed, by the server in FIG. 1, at the time the reservation is made for the job, according to an exemplary embodiment;

FIG. 7B is a diagram showing an example of a list of jobs stored in the server for which reservations were made by a reserver userA, according an exemplary embodiment;

FIG. 8 is a diagram showing an example email that is transmitted, when the user who has been employing the image forming apparatus logs out, to the first of the remaining users who have made reservations, according to an exemplary embodiment;

FIG. 9 is a diagram showing a re-authentication screen of the image forming apparatus employed for re-authentication by a user who has made a reservation, according to an exemplary embodiment;

FIG. 10 is a diagram showing an example current user list screen for users who have made reservations for the image forming apparatus, according to an exemplary embodiment;

FIG. 11 is a diagram showing an example print job selection screen for users who have made reservations, according to an exemplary embodiment;

FIG. 12 is a diagram showing an example email transmitted by the image forming apparatus to a user who has made a reservation, when re-authentication by the user has not been obtained, even after a job use period has elapsed, according to an exemplary embodiment;

FIG. 13 is a flowchart showing example first control processing performed by the image forming apparatus according to an embodiment of the present invention;

FIG. 14 is a flowchart showing example second control processing performed by the image forming apparatus according to an embodiment of the present invention;

FIG. 15 is a flowchart example showing first control processing performed by a server according to an embodiment of the present invention;

FIG. 16 is a flowchart showing third control processing performed by the image forming apparatus according to an embodiment of the present invention;

FIG. 17 is a flowchart showing fourth control processing performed by the image forming apparatus according to an embodiment of the present invention;

FIG. 18 is a diagram showing a screen displayed on the touch panel of an image forming apparatus, according to a second embodiment of the present invention, after a user who has made a reservation has used the image forming apparatus to perform user authentication;

FIG. 19 is a flowchart showing example fifth control processing performed by the image forming apparatus according to an embodiment of the present invention;

FIG. 20 is a flowchart showing example sixth control processing performed by the image forming apparatus according to an embodiment of the present invention;

FIG. 21 is a diagram for explaining a memory map for a storage medium (recording medium) on which various data processing programs, readable by the image forming apparatus according to an embodiment of the present invention, are stored; and

FIG. 22 is a diagram for explaining a memory map for a storage medium (recording medium) on which various data processing programs, readable by the server are stored, according to an exemplary embodiment.

### DESCRIPTION OF THE EMBODIMENTS

### First Exemplary Embodiment

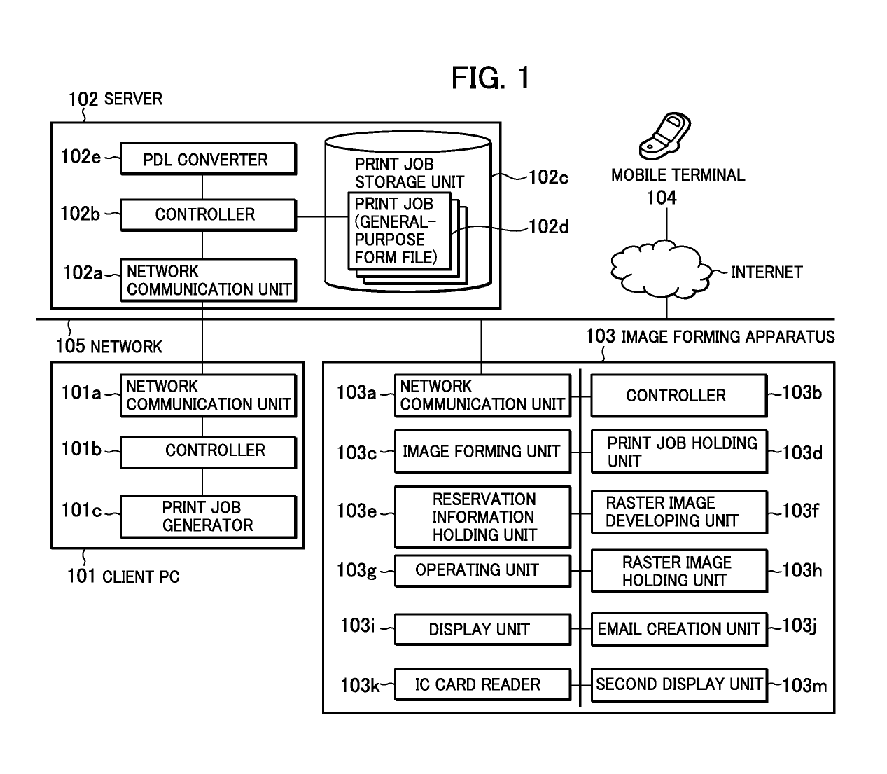

FIG. 1 is a system configuration diagram showing an example, general configuration for a pull print system according to a first embodiment of the present invention. The configuration and the pull print process will now be described.

As shown in FIG. 1, in the pull print system of this embodiment, a client PC 101, which is an information terminal apparatus, a server 102, which is an information processing apparatus, an image forming apparatus 103 and a portable terminal 104 are connected via a network 105. In this embodiment, the network 105 may be a LAN, a wireless LAN, the Internet or any combination thereof.

First, when the client PC 101 registers a print job with the server 102, a print job generator 101c of the client PC 101 generates a print job for a general-purpose form file, such as a PDF file, that has less model dependency. Then, a controller 101b transmits the generated job to the server 102 via a network communication unit 101a and the network 105. The controller 101b controls the processes performed by the components associated with the registration of a print job.

When an image forming apparatus 103 that performs pull printing is determined in advance, the client PC 101 may prepare PDL data, the use of which depends on models, and the controller 101b may transmit the PDL data to the server 102 (another embodiment).

It should be noted that the components of the client PC 101 include a CPU, a ROM, a RAM and a storage device (e.g., HDD), and that the CPU reads a program from the HDD to the RAM and provides the functions associated with the above described sections.

In the server 102, a network communication unit 102a receives a print job, and this print job is thereafter stored in a print job storage unit 102c. A controller 102b controls the processes performed by the individual components related to the submission of a request for the registration of a print job.

It should be noted that the components of the server 102 include a CPU, a ROM, a RAM and a storage device (e.g., HDD), and that the CPU reads a program from the HDD to the RAM, and provides the functions associated with the above described sections.

Next, when the image forming apparatus 103 performs pull printing for a print job stored in the server 102, a user employs an IC card reader 103k or an operating unit 103g of the image forming apparatus to perform user authentication.

The controller 103b transmits to the server 102, via a network communication unit 103a, user authentication information for a current user entered using the IC card reader 103k or the operating unit 103g, and obtains from the server 102 a list of print jobs the current user can print and displays the list on a display unit 103i. The user then selects a print job using the operating unit 103g, and the controller 103b downloads to a print job holding unit 103d the print job designated by the user.

Finally, the controller 103b permits a raster image developing unit 103f to develop the print job and provide a raster image, and permits an image forming unit 103c to perform image forming on a recording material (i.e., to perform printing). In this manner, the controller 103b controls the operations of the individual components related to the printing process. It should be noted that the components of the image forming apparatus 103 include a CPU, a ROM, a RAM and a storage device (e.g., HDD), and that the CPU reads a program from the HDD to the RAM and provides the functions performed by the above described sections.

Further, based on the user authentication information for the current user received by the network communication unit 102a, the controller 102b of the server 102 transmits to the image forming apparatus 103 a list of print jobs that this user can print. In addition, when the controller 102b receives a selected print job and device information for the image forming apparatus 103, a PDL converter 102e converts the selected print job 102d into PDL data that can be printed using the obtained device information, and transmits the PDL data to the image forming apparatus 103. In this manner, based on authentication information, the controller 102b controls the operations of the components related to the process for obtaining a print job 102d from the print job storage unit 102c, and the printing process.

Processing of a pull print reservation at the image forming apparatus 103 will now be described.

In accordance with an embodiment of the present invention, even when a user is logging in at an image forming apparatus 103, a pull print reservation by another user can be accepted.

When a pull print reservation is to be accepted by an image forming apparatus 103, the controller 103b of the image forming apparatus 103 employs the IC card reader 103k to obtain user authentication information for the user requesting the reservation, and stores the information for this user in the reservation information holding unit 103e.

In parallel with manipulation/printing/reading operations performed by an image forming unit 103c for print jobs, for a current user, for which reservations were made and that are held in the server 102, the controller 103b downloads PDL data for a print job that satisfies a predetermined condition, and stores this data in the print job holding unit 103d. Further, the controller 103b employs the raster image developing unit 103f to develop PDL data stored in the print job holding unit 103d, and stores the results in a raster image holding unit 103h.

When the preceding user has completed the operation, the controller 103b employs an email creation unit 103j to create and to transmit an email to the client PC 101 or the portable terminal 104 so as to notify the user who has made a reservation that the requested device is now available. Furthermore, for a predetermined period of time, the controller 103b does not accept manipulation of the operating unit 103b by a user other than one who has made the reservation. The image forming apparatus stores email addresses of client PCs or portable terminals in a storage unit (not shown) in correlation with user authentication information, so that an email can be transmitted to the client PC or the portable terminal 104 of the user who has made the reservation to notify the user that the requested device is available.

When the server 102 receives authentication information for the user who made the reservation, the server 102 obtains from the print job storage unit a print job that satisfies a predetermined condition and transmits the print job to the image forming apparatus 103.

When a user who has made a reservation is to perform pull printing using the image forming apparatus 103, that user performs re-authentication, using the IC card reader 103k or the operating unit 103g of the image forming apparatus 103. In the image forming apparatus 103, the controller 103b obtains the user authentication information for user who has made a reservation via the IC card reader 103k or the operating unit 103g of the image forming apparatus 103. Then, the controller 103b transmits the user authentication information for that user to the server 102 via the network communication unit 103a. Thereafter, the controller 103b receives from the server 102 a list of print jobs the current user can print, and displays the list on the display unit 103i to permit the user to select one.

Sequentially, when the selected print job is present in the print job holding unit 103d or the raster image holding unit 103h of the image forming apparatus 103, the controller 103b obtains the job from the pertinent holding unit and permits the image forming unit 103 to print the job. Therefore, the printing time can be reduced. When a selected job has not been preprocessed, the controller 103b performs the normal pull printing process described above. That is, the controller 103b downloads PDL data for the selected job from the server 102, employs the raster image developing unit 103f to develop the PDL data, and uses the image forming unit 103c to print the obtained data.

The image forming unit 103c may be either a laser beam type or another electrophotographic type, such as an LED. Further, embodiments of the present invention can also be applied to other suitable types of image forming unit, including a liquid crystal shutter type, an inkjet type, a thermal transfer type, a sublimation type or another printing type.

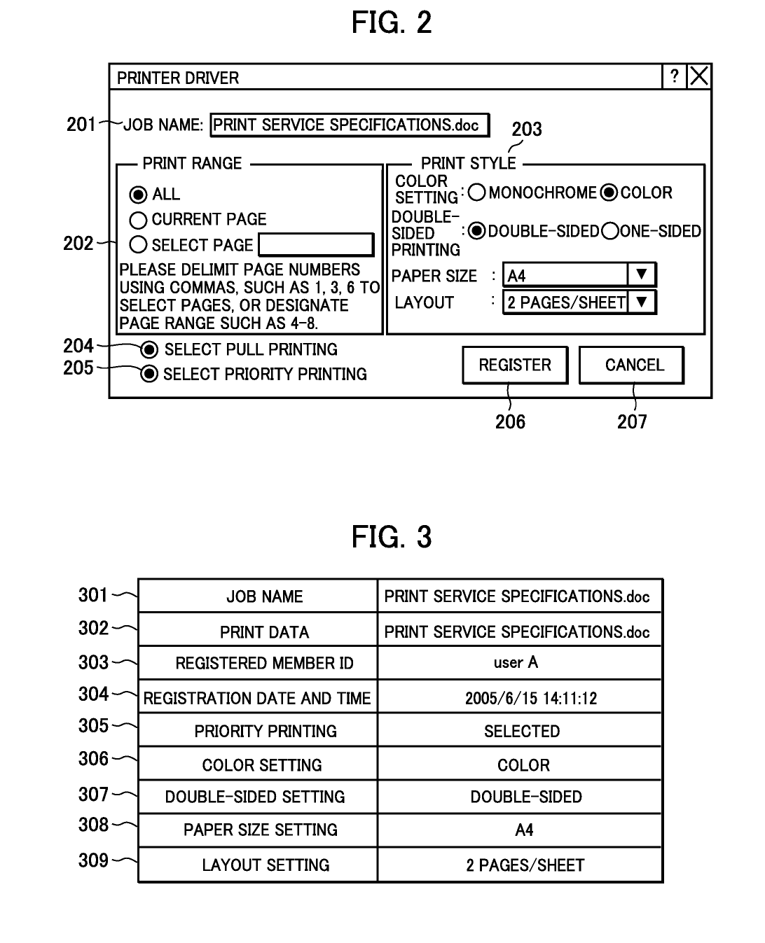

FIG. 2 is a print job registration screen displayed on the monitor of the client PC 101 in FIG. 1 when the client PC 101 registers a print job with the server 102 according to an embodiment of the present invention.

Specifically, this is a setup screen for a printer driver (corresponding to the print job generator 101c in FIG. 1) that is installed in the client PC 101 used for this embodiment. When the print instruction button of the application or the WEB browser of the client PC 101 is pressed, in accordance with an instruction issued by the controller 101b, the printer driver registration screen is displayed by the print job generator 101c.

On the registration screen in FIG. 2, a job name input portion 201 is used to enter the title of a job to be registered. A print range designation portion 202 is used to designate a range, for a document that is currently being edited, to generate and register a print job.

A print style designation portion 203 is used to designate a print style in advance at the time a print job is registered, and to designate color/monochrome printing, double-sided/single-sided printing, paper size and page layout. In this embodiment, the print style designation portion includes the above four entries; however, a printing direction and a staple setting may also be included.

A pull print designation portion 204 is used to designate pull printing for a print job. When the pull print designation portion 204 is selected, the print job is transmitted and registered with the server 102. But when the pull print designation portion 204 is not selected, the print job is transmitted directly to the image forming apparatus 103 and printed.

A priority print designation portion 205 is selected when the immediate printing of a print job to be registered is desired. When a pull print reservation, which will be described later, is made for print jobs stored in the server 102 for a user making a reservation, the image forming apparatus 103 performs a preprocess, such as downloading, for a print job that satisfies a predetermined condition. In this case, the image forming apparatus 103 performs the preprocess for a print job for which priority printing is designated, before performing it for other jobs.

In order to prevent a user from designating priority printing for all print jobs registered, an upper limit may be set for the number of jobs for which priority printing may be designated (another embodiment). For example, if there are three jobs for which priority printing has been designated in the server 102, further priority printing designations may be inhibited.

A job registration button 206 is used to register a print job with the server 102 in consonance with designated contents. A cancel button 207 is used to cancel the registration of a print job, and to return to the application or to the WEB browser that called up the job registration screen.

In this embodiment, the print job registration screen (FIG. 2) is regarded as a printer driver screen. However, a WEB browser may access the server 102 and download the same screen, and display it to enable registration of print jobs (another embodiment).

Furthermore, in the above explanation for this embodiment, the print job generator 101c of the client PC 101 converts a document into a PDF file, and registers the PDF file with the server 102. However, an application document may be registered directly with the server 102 without being converted into a PDF file.

FIG. 3 is a diagram showing an example data structure for the print job information 102d registered with the server 102 in FIG. 1 according to an embodiment of the present invention.

As the print job information 102d, the following information 301 to 309 is stored in correlation with a job registered with the server 102. For example, job name 301, print data 302, registered member ID 303, registration date and time 304, priority print selection 305, color setting 306, double-sided setting 307, paper size setting 308 and layout setting 309 information are stored in correlation with the job.

The job name 301 corresponds to a job title entered using the print job registration screen in FIG. 2, and the print data 302 corresponds to general-purpose form print data for a print job.

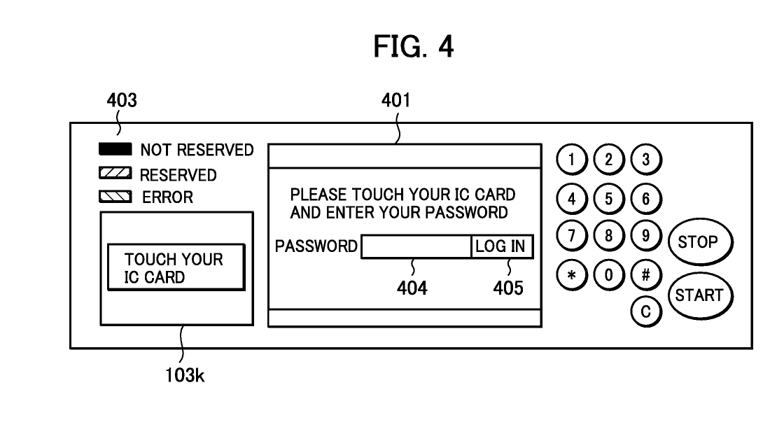

FIG. 4 is a plan view of the arrangement of the display unit 103i and the operating unit 103g of the image forming apparatus 103 shown in FIG. 1. The example shown in FIG. 4 corresponds to a case wherein the operating screen (user authentication screen) for user authentication for pull printing is displayed. This user authentication screen corresponds to a screen that is displayed first when a preceding user or a user who made a reservation is not present at the image forming apparatus 103, and normal pull printing is to be performed.

In FIG. 4, a touch panel 401 corresponds to the display unit 103i and the operating unit 103g of the image forming apparatus 103 in FIG. 1. In the case shown in FIG. 4, the user authentication screen, controlled by the controller 103b, is displayed on the touch panel 401 to accept an entry by a current user.

The IC card reader 103k is used to retrieve user authentication information from the IC card of the current user.

An LED portion 403 includes: a first LED, which is turned on when no reservations have been made for the image forming apparatus 103; a second LED, which is turned on when a reservation has been made for the image forming apparatus 103; and a third LED, which is turned on when an error occurs while user authentication information is being retrieved from an IC card. Referring to FIG. 4, if no reservation has been made for the image forming apparatus 103, the first LED on the screen is lighted. It should be noted that the lighting of the LED portion 403 is controlled by the controller 103b.

A password input portion 404 is used to accept the input of a password by the current user after the user authentication information has been retrieved by the IC card reader 103k. A login button 405 is pressed to log in after the user authentication information has been retrieved by the IC card reader 103k and the password has been accepted by the password input portion 404. It should be noted that the password input process and the log in process are performed by the controller 103b.

In the state shown in FIG. 4, the screen corresponds to a case where no user has previously logged in, when the image forming apparatus 103 is employed. Accordingly, a current user can touch the user IC card to the IC card reader 103k, enter a password at the password input portion 404, and press the login button 405 to log in. Following this, the operation of the device is initiated.

To input user authentication information, instead of using the IC card reader 103k, a user ID and a password can be manually entered using the touch panel 401. Alternatively, the user authentication information may be entered via infrared communication, or by using USB media, a two-dimensional barcode, or bioauthentication (another embodiment).

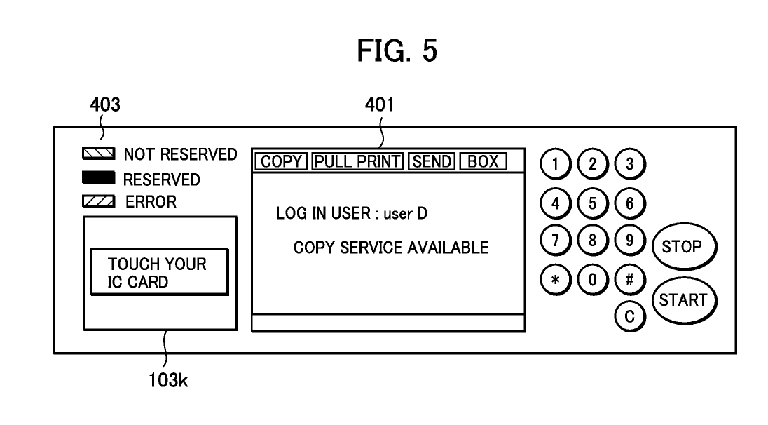

FIG. 5 is a diagram for explaining an operating screen used to request a pull printing reservation at the image forming apparatus 103 while the image forming apparatus 103 is being employed by another user. The same reference numerals are provided for the same components as those in FIG. 4.

In FIG. 5, since a message indicating that a preceding user (userD) is logged in is displayed on the touch panel 401, a subsequent user desiring to make a pull printing reservation cannot use the touch panel 401. Further, in this embodiment, to provide notification that an operation is currently being performed, a message is displayed that a user is currently logged in at the image forming apparatus 103.

When a user has previously logged in at the image forming apparatus 103, a subsequent user desiring to make a reservation touches a user IC card to the IC card reader 103k and enters user authentication information, so that under the control of the controller 103b, a pull printing reservation can be made.

Normally, when a pull print reservation is made, the second LED of the LED portion 403 is turned on by the controller 103b. But when user authentication information cannot be correctly retrieved from the IC card, or when the number of reservations for the image forming apparatus 103 has reached a predesignated upper limit (e.g., three), the third error LED is turned on by the controller 103b.

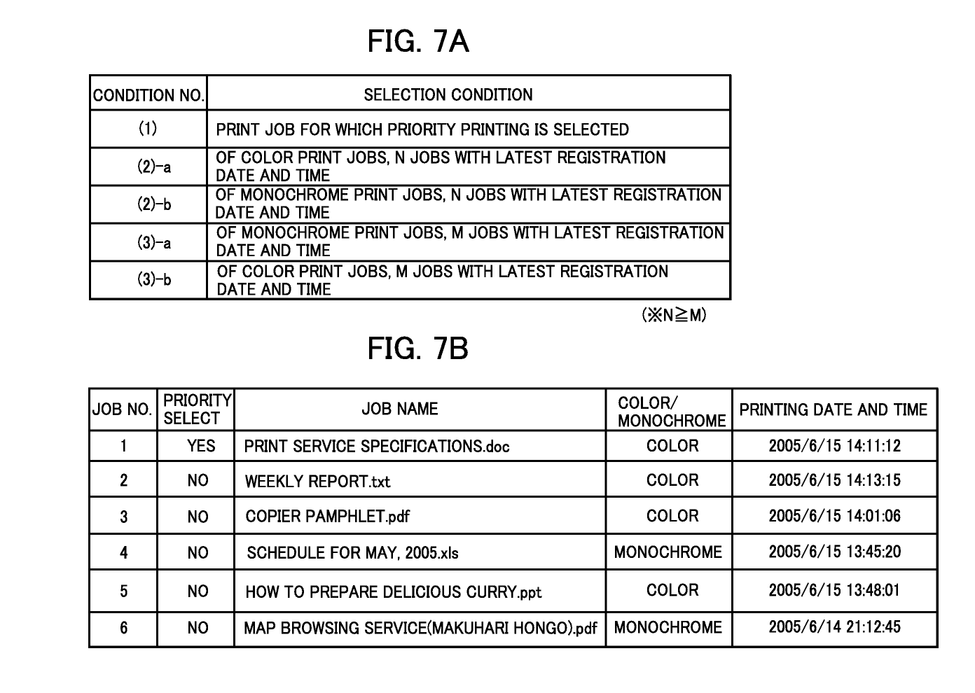

In addition, when a pull print reservation is made normally, the controller 103b performs a pull print preprocess parallel to the manipulation/printing/reading process being performed by the preceding user. The pull print preprocess corresponds to a process wherein, of the print jobs held in the server 102 for a user who has made a reservation, a print job consonant with the condition shown in FIG. 7A, which will be described later, is downloaded from the server 102 and is developed. It should be noted that a print job downloaded from the server 102 is a job for which the server 102 has performed a PDL conversion.

Furthermore, in this embodiment, the LED portion 403 is employed to confirm the acceptance of a pull print reservation or the presence/absence of a reservation, and to confirm that an error occurred while a reservation was being made. Sounds, however, may also be employed for these confirmations (another embodiment). In such a case, different sounds are employed to confirm the reception and acceptance of a reservation and to confirm that an error has occurred, so that a normal case and a case wherein an occurred can be identified.

Further, in this embodiment, a pull printing reservation can be made by touching the IC card to the IC card reader 103k. However, to prevent an erroneous pull print reservation being made due to the accidental touching of the IC reader 103k with an IC card, a pull printing reservation may be designated by sequentially and repeatedly touching the IC card reader 103k with the IC card a plurality of times (another embodiment).

Also, when a pull print application is included in the image forming apparatus 103, the controller 103b performs a pull print preprocess at the time a reservation is made. However, when a reservation designated for the image forming apparatus 103 does not include a pull print application, the controller 103b may not perform a pull print preprocess and may make a reservation only for the right to use the image forming apparatus 103 (another embodiment).

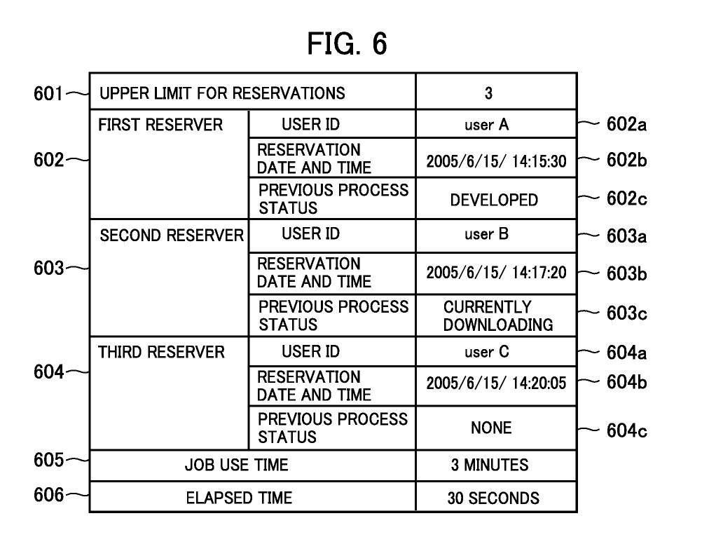

FIG. 6 is a diagram showing the data structure of reservation information that is stored in the reservation information holding unit 103e of the image forming apparatus 103 when a pull printing reservation is made.

Items 601 to 606 in FIG. 6 are correlated with each other in the reservation information. For example, an upper reservation limit 601, first user reservation information 602, second user reservation information 603, third user reservation information 604, job use time 605 and elapsed time 606 are included in the reservation information. The upper reservation limit 601 indicates the maximum number of reservations that the image forming apparatus 103 can accept. As for the first user reservation information 602, the second user reservation information 603 and the third user reservation information 604, beginning with the oldest reservation date and time, users are designated as a first reserver, a second reserver and a third reserver. Further, the first user reservation information 602, the second user reservation information 603 and the third user reservation information 604 include user IDs 602a to 604a, reservation dates and times 602b to 604b and information 602c to 604c concerning the state of the pull print process.

In the example in FIG. 6, the first reserver is “userA”, and as the preprocess for userA, the job has been partially developed. The second reserver is “userB”, and as the preprocess for userB, part of the job is currently being downloaded. The third reserver is “userC”, and the preprocess for userC is not yet being performed.

The job use time 605 and the elapsed time 606 are respectively a period during which the image forming apparatus 103 can be used exclusively for the first reserver and the elapsed time for the exclusive use period.

FIG. 7A is a diagram showing a selection condition for a job for which the server 102 performs a preprocess at the time the reservation is made.

When a pull print reservation is designated, the server 102 performs the pull print preprocess for a job selected in accordance with a selection condition. The selection processing will now be described.

First, for condition No. (1), wherein priority printing is designated for a print job included in print jobs that are registered, it is assumed that this print job highly probably will be printed by a reserver, and the CPU of the server 102 regards this job as a print job for which a preprocess should be performed first.

For conditions No. (2) and No. (3), when a reserver of the image forming apparatus 103 has made a pull print reservation to use a color printer, the CPU of the server 102 permits the use of selection conditions No. (2)-a and No. (3)-a. When a reserver of the image forming apparatus 103 has made a pull print reservation to use a monochrome printer, the CPU of the server 102 permits the use of selection conditions No. (2)-b and No. (3)-b.

When the user of the image forming apparatus 103 has reserved a color printer, it is highly probable that the reserver will select and print a color print job. Based on this presumption, the CPU of the server 102 regards color print jobs as jobs for which a preprocess should be performed first, before monochrome print jobs (e.g., selection condition No. (2)-a). Further, since there is a probability that the reserver may perform monochrome printing, even though the image forming apparatus 103 is a color printer, the CPU of the server 102 also regards monochrome print jobs as preprocess targets while the number of target jobs is smaller than the number of color print jobs (e.g., selection condition No. (3)-a). In this embodiment, N for condition No. (2) is two and M for No. (3) is one.

FIG. 7B is a diagram showing a list of jobs stored in the server 102 for reserver userA. While referring to FIG. 7B, an explanation will now be given for a method whereby a print job for which a preprocess is to be performed is selected in accordance with a selection condition in FIG. 7A. It should be noted that the image forming apparatus 103 that userA has reserved for pull printing is a color printer.

First, in accordance with condition No. (1) in FIG. 7A, the CPU of the server 102 determines that print job No. 1, for which priority printing is designated, should be the first to be preprocessed.

Then, in accordance with condition No. (2)-a, the CPU of the server 102 selects color print jobs No. 2, No. 3 and No. 5 as preprocess target choices, and determines that the two jobs No. 2 and No. 3, which have the latest registration dates, are the jobs that are to be preprocessed next.

Finally, in accordance with condition (3)-a, the CPU of the server 102 selects monochrome print jobs No. 4 and No. 6 as preprocess target choices, and determines that job No. 4, which has the latest registration date, is the job that is to be preprocessed last.

That is, the CPU of the server 102 determines the preprocess performance order for userA jobs No. 1, No. 2, No. 3 and No. 4 that are stored in the server 102.

Further, in this embodiment, the latest N color jobs and M monochrome jobs are regarded as jobs for the preprocess. However, of the color/monochrome jobs, jobs registered within a specific period (e.g., 30 minutes) may be regarded as those for the preprocess, or another selection condition may be employed (another embodiment).

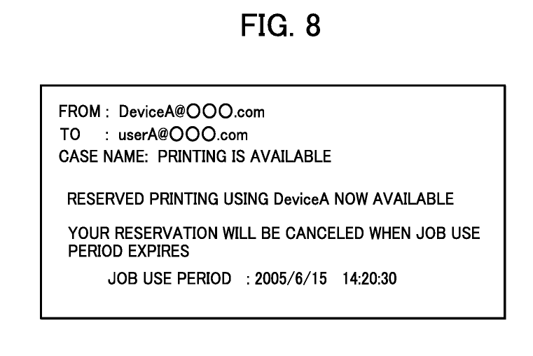

FIG. 8 is a diagram showing an example email that is transmitted by the image forming apparatus 103 to the first reserver when the preceding user has logged out of the image forming apparatus 103.

As shown in FIG. 8, the text of this email includes a notice that printing is now available at the image forming apparatus 103 reserved for pull printing, a notice that the reservation will be canceled after the job use time has expired, and the job use period for the image forming apparatus 103.

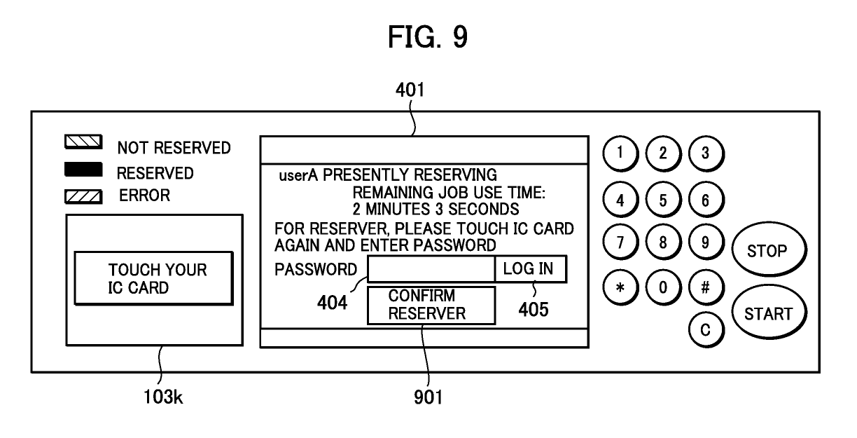

FIG. 9 shows a re-authentication screen of the image forming apparatus 103 when a reserver performs re-authentication. The same reference numerals as those in FIG. 4 are provided for corresponding components. This screen is displayed on the touch panel 401, since the preceding user will not log out until the job use period for a reserver has elapsed.

On the touch panel 401, a message that the image forming apparatus 103 is currently being used by a reserver, and the use time remaining for the reserver of the image forming apparatus 103 are displayed by the controller 103b. Additionally, this re-authentication screen displayed by the controller 103b has a display form that differs from the normal form of the touch panel 401 (e.g., employs different colors) in order to indicate that the image forming apparatus 103 is currently being used. Another form, such as a blinking form, may also be employed.

Also displayed by the controller 103b is a message that the reserver userA is currently employing the image forming apparatus 103, and the remaining use time for userA.

When the reserver userA performs pull printing using the image forming apparatus 103, userA again touches the IC card reader 103k with the IC card and transmits user authentication information. Further, userA again enters the password in the password input portion 404, and presses the login button 405.

Since the image forming apparatus 103 is currently employed only by reserver userA, the controller 103b does not permit a user other than userA to operate the touch panel 401 of the image forming apparatus 103. Therefore, no other user can touch an IC card to the IC card reader 103k to make use of the succeeding pull print reservation.

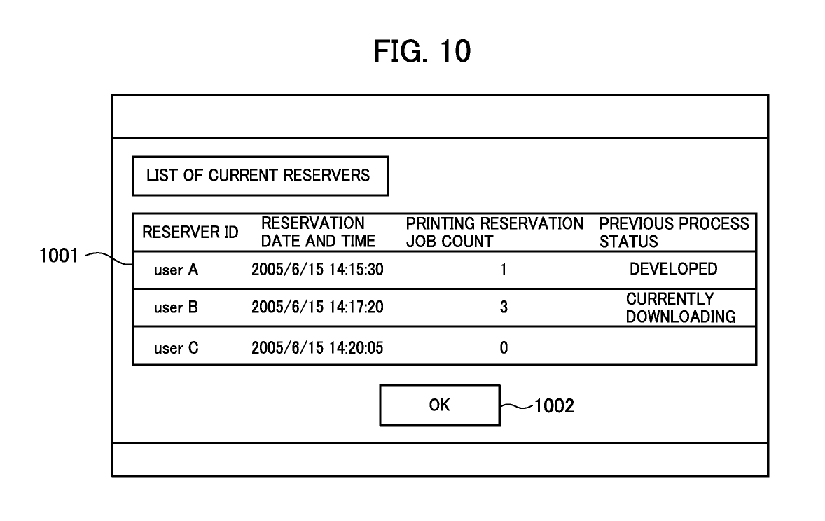

A reserver confirmation button 901 is used to display a list of the users who currently have reservations for the use of the image forming apparatus 103. When this button 901 is pressed, the controller 103b displays a reserver list screen (FIG. 10).

Furthermore, in this embodiment, since only the pull print preprocess is performed at the time the reservation is made, user authentication can only be enabled by using the IC card. However, when pull printing is actually to be performed, in order to provide improved security, user authentication information is transmitted using the IC card and the password is entered thereafter to perform the user authentication in FIG. 4 and the reserver re-authentication in FIG. 9. In this case, in order to increase usability, only user authentication information need be transmitted using an IC card to enable the user authentication in FIG. 4 and the reserver re-authentication in FIG. 9 (another embodiment).

FIG. 10 is a diagram showing an example screen for a list of current reservers for the image forming apparatus 103. This list is displayed on the touch panel 401 when the reserver confirmation button 901 is pressed on the reserver re-confirmation screen shown in FIG. 9.

In FIG. 10, reserver list information 1001 contains various information concerning current reservers for the image forming apparatus 103, including a reserver ID, a reservation date and time, the number of print reservation jobs and a preprocess state.

While referring to FIG. 10, the preprocess states can be understood at a glance by using different colors, e.g., blue is used for a user whose preprocess state indicates developed, and yellow is used for a user whose preprocess state indicates downloaded. That is, the controller 103b changes the display forms for users in accordance with their preprocess states.

“0” is entered as the number of print reservation jobs for userC. This indicates that a job that satisfies a predetermined condition is not present in print jobs for userC stored in the server 102. UserC has reserved only the right to use the device in order to perform copying, for example.

An OK button 1002 is to be pressed when a user confirms the current reserver list information 1001. By pressing this OK button 1002, the controller 103b returns the reserver list screen to the screen shown in FIG. 9.

A second display unit 103m, such as a small display unit, may be arranged near the IC card reader 103k of the image forming apparatus 103. The contents of the reserver list screen in FIG. 10 may be displayed on the second display unit 103m, so that, at the time the reservation is made, a user can confirm the list of users who have reserved the image forming apparatus 103 (another embodiment).

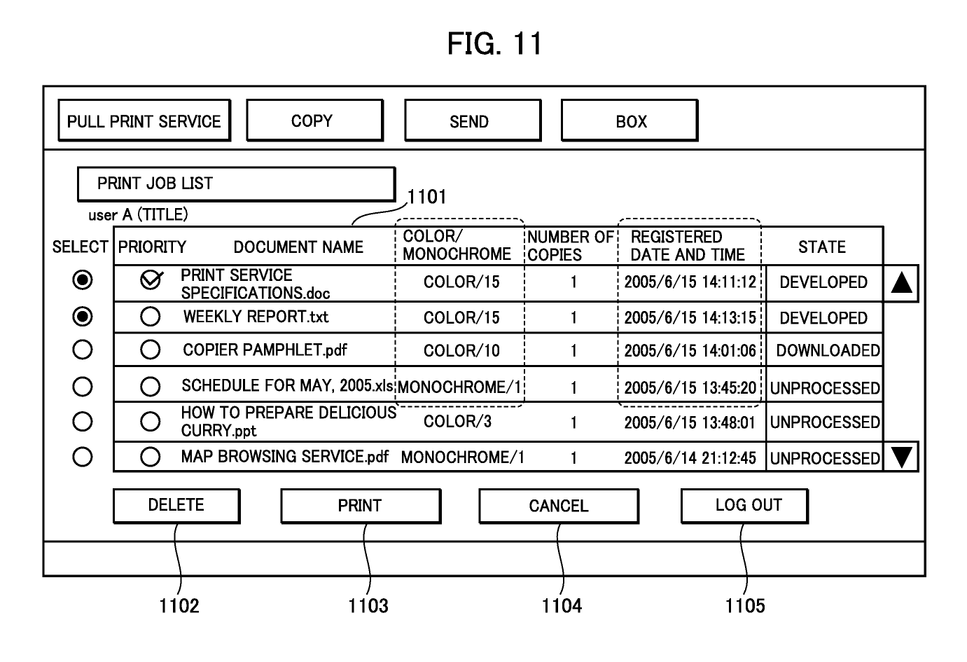

FIG. 11 is a diagram showing a print job selection screen for a reserver. When a reserver has pressed the login button 405 in FIG. 9 for re-authentication, the controller 103 displays the print job selection screen on the touch panel 401.

In FIG. 11, a print job list display portion 1101 is used to display the list of jobs for reservers that are held in the server 102. The print job list display portion 1101 includes a priority, a document name, color/monochrome, the number of pages, the number of copies, date and time when a document was registered into the server, and a preprocess state.

In the example shown in FIG. 11, of the four print jobs that have been explained while referring to FIG. 7B and that are targets for a preprocess, the first two jobs have been developed, and the third job has been downloaded according to the preprocess states. And in this state, the reserver is re-confirming the print jobs.

Furthermore, the user can select a print job by touching jobs displayed on the print job list display portion 1101.

A delete button 1102 is used to delete a selected job from the server 102. A print button 1103 is used to start the printing of the selected job. For normal pull printing, upon the pressing the print button 1103, the server 102 converts PDF data into PDL data, and the image forming apparatus 103 downloads the PDL data, develops it to obtain raster image data, and starts printing thereafter. However, for example, for a print job that has been developed, since the image forming apparatus 103 can immediately initiate printing, the printing period can be reduced.

Further, when the print button 1103 is pressed while a plurality of jobs are selected, the controller 103b automatically begins printing in order a job that has been developed to obtain raster image data, a job that has been downloaded and a job that has not yet been processed. Since parallel to the printing of a job that has been developed to obtain raster image data, the controller 103b performs either raster image developing for a downloaded job or downloads an unprocessed job, the printing processing can be efficiently performed.

A cancel button 1104 is used to cancel the selection of a print job. A logout button 1105 is used to instruct the logging out of the image forming apparatus 103. Upon pressing the logout button 1105, the controller 103b deletes the preprocessed print jobs that are stored in the print job holding unit and the raster image holding unit 103h of the image forming apparatus 103. When the next reserver is present, the controller 103b transmits to that reserver an email (FIG. 8) indicating that the image forming apparatus 103 is now available.

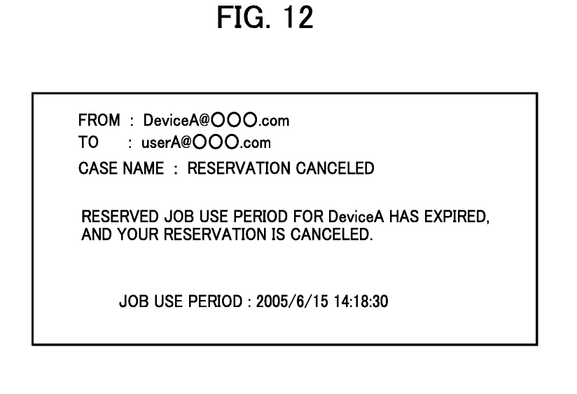

FIG. 12 is a diagram showing an example email that is transmitted, under the control of the controller 103b, by the image forming apparatus 103 to a reserver when the re-authentication by the reserver is not obtained after the job use period has elapsed.

As shown in FIG. 12, the text of the email includes a notice that a reservation has been canceled because the job use period has expired. Further, when this email is to be transmitted, the controller 103b deletes print jobs that are held in the print job holding unit 103d and the raster image holding unit 103h of the image forming apparatus 103, and that have been preprocessed for this reserver.

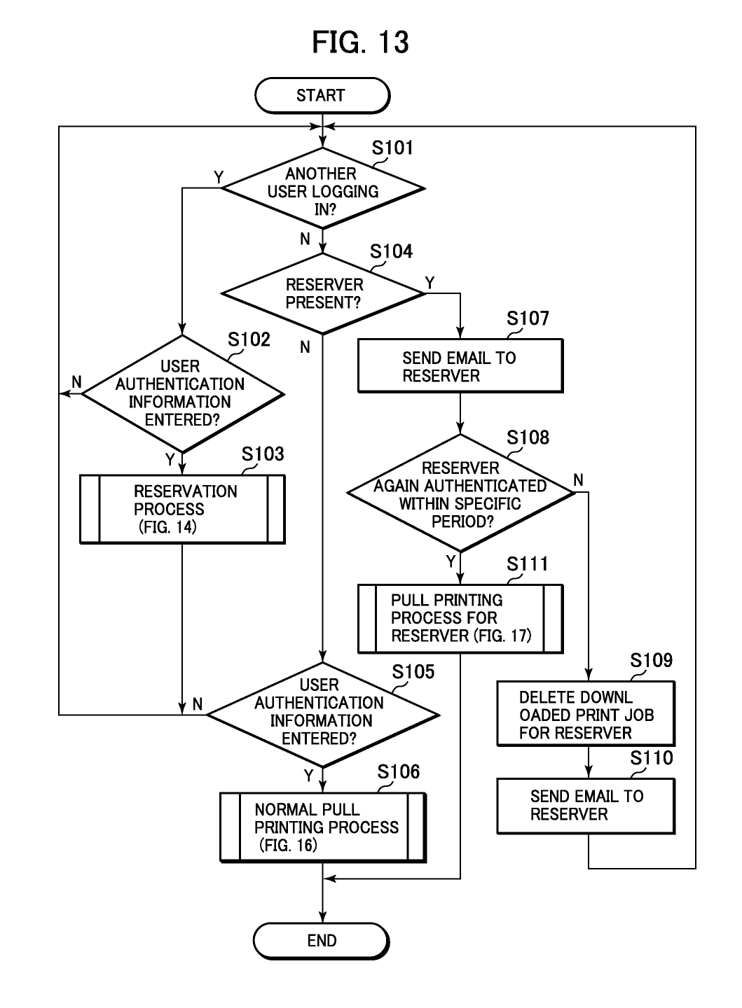

While referring to FIGS. 13 to 17, a detailed explanation will now be given for the processing performed by the image forming apparatus 103 and the server 102 according to the first embodiment.

FIG. 13 is a flowchart showing example first control processing performed by the image forming apparatus 103 of the present invention. This first control processing corresponds to the general processing performed by the controller 103b of the image forming apparatus 103. In an embodiment, the processing in this flowchart is performed by the controller 103b that is provided when the CPU of the image forming apparatus 103 reads, to the RAM, a program stored on an HDD or another storage medium, and executes this program. In FIG. 13, S101 to S111 represent individual steps.

First, at step S101, the controller 103b determines whether a user is currently logged in for the image forming apparatus 103. When the controller 103b determines that there is a user who is currently logged in, as shown in FIG. 5, the controller 103b assumes that this user is manipulating the operating unit 103g and advances the processing to step S102. At step S102, the controller 103b determines whether user authentication information for a reserver has been entered by the IC card reader 402. When the controller 103b determines that user authentication information for a reserver has not been entered by the IC card reader 103k, the controller 103b returns the processing to step S101.

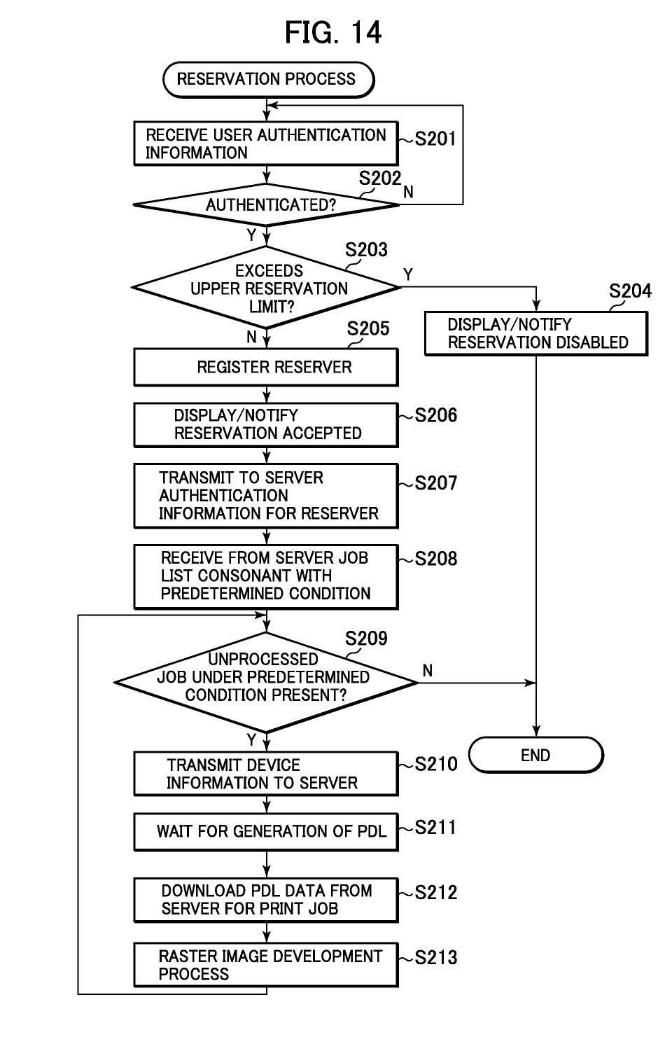

When, at step S102, the controller 103b determines that user authentication information for a reserver has entered by the IC card reader 402, the controller 103b advances the processing to step S103. At step S103, the controller 103b performs a reservation process shown in FIG. 14, which will be described later, and then returns the processing to step S101.

When, at step S101, the controller 103b determines that no user is currently logged in for the image forming apparatus 103, the controller 103b advances to the processing to step S104.

At step S104, the controller 103b determines whether there is a reservation for the image forming apparatus 103. When the controller 103b determines that there is no reservation for the image forming apparatus 103, the controller 103b advances the processing to step S105.

At step S105, the controller 103b displays the user authentication screen shown in FIG. 4 on the touch panel 401, and determines whether user authentication information and a password have been entered, using the user authentication screen in FIG. 4, via the IC card reader 103k. When the controller 103b determines that user authentication information and a password have not been entered, the controller 103b returns the processing to step

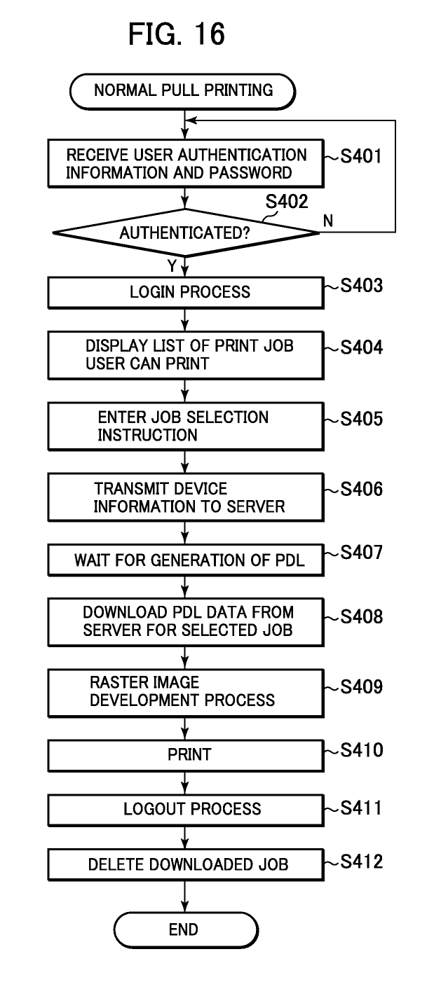

When, at step S105, the controller 103b determines that user authentication information and a password have been entered, the processing proceeds to step S106 where the controller 103b performs the normal pull printing shown in FIG. 16, which will be described later, and returns the processing to step S101.

When, at step S104, the controller 103b determines that the image forming apparatus 103 has been reserved, the controller 103b advances the processing to step S107. And at step S107, the controller 103b transmits to the reserver an email, shown in FIG. 8, that includes a notice indicating that the image forming apparatus 103 is available, and a job use period. Specifically, the controller 103b examines email addresses stored in the storage unit (not shown), and transmits an email in FIG. 8 to the email address that corresponds to the reserver.

At step S108, the controller 103b displays the screen shown in FIG. 9 on the touch panel 401, and determines whether re-authentication for the reserver has been obtained within the job use period. It should be noted that for re-authentication the reserver enters user authentication information using the IC card reader 103k and a password entered using the screen shown in FIG. 9.

When, at step S108, the controller 103b determines that re-authentication for the reserver has not been obtained within the job use period, the controller 103b advances the processing to step S109. At step S109, the controller 103b deletes from the print job holding unit 103d the print jobs for the reserver that were downloaded from the server 102, and advances the processing to step S110. At step S110, the controller 103b transmits, to the reserver, an email, shown in FIG. 12, indicating that the reservation has been canceled because the job use period has expired. Specifically, the controller 103b examines email addresses stored in the storage unit (not shown), and transmits an email shown in FIG. 12 to the email address corresponding to the reserver. Thereafter, the controller 103b returns the processing to step S101.

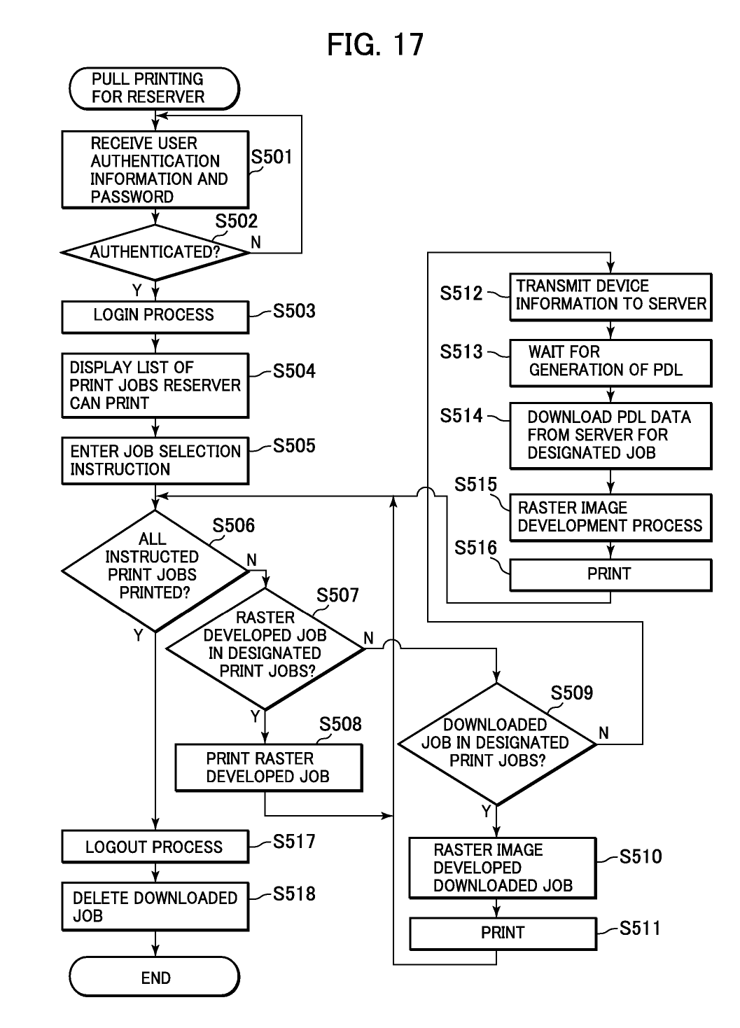

When, at step S108, the controller 103b determines that re-authentication for the reserver has been obtained within the job use period, the controller 103b advances the processing to step S111. At step S111, the controller 103b performs the pull printing process for the reserver that is shown in FIG. 17 and that will be described later, and returns the processing to step S101.

In this case, the reservation processing is performed by the controller 103b as multiprocessing, whereby a plurality of reservation processes are performed in parallel. Furthermore, the reservation process and the normal pull printing process, or the reservation process and the pull printing process for a reserver are performed in parallel as multiprocessing by the controller 103b. For example, the reservation process for a reserver is performed parallel to the manipulation/printing/reading process for the preceding user.

FIG. 14 is a flowchart showing example second control processing performed by the image forming apparatus 103 according to an embodiment of the present invention. This processing illustrated in FIG. 14 corresponds to the reservation process at step S103 in FIG. 13. The processing in this flowchart is to be performed by the controller 103b, which is provided when the CPU of the image forming apparatus 103 reads to the RAM a program stored on an HDD or another storage medium, and executes this program. It should be noted that S201 to S213 in FIG. 14 indicate individual steps.

First, at step S201, the controller 103b receives user authentication information entered by the IC card reader 103k, and advances the processing to step S202. At step S202, the controller 103b performs user authentication based on the user authentication information received at step S201, and determines whether user authentication has been successful. When, at step S202, the controller 103b determines that user authentication has not been successful, the controller 103b returns the processing to step S201 and waits for the re-entry of user authentication information.

When, at step S202, the controller 103b determines that user authentication has been successful, the processing proceeds to step S203 where the controller 103b determines whether the upper reservation limit of the image forming apparatus 103 has not been exceeded. When, at step S203, the controller 103b determines that the upper reservation limit for the image forming apparatus 103 has been exceeded, the controller 103b shifts the processing to step S204. At step S204, the controller 103b turns on the error LED, for example, in the LED portion 403 to notify the reserver the reservation has been canceled, and terminates the processing.

On the other hand, when, at step S203, the controller 103b determines that the upper reservation limit for the image forming apparatus 103 has not been exceeded, the controller 103b advances the processing to step S205. At step S205, the controller 103b registers the current user as a reserver with the reservation information holding unit 103e of the image forming apparatus 103, and at step S206, the controller 103b turns on the second LED, for example, in the LED portion 403 to notify the user that the reservation has been accepted.

At step S207, the controller 103b transmits to the server 102 the user authentication information (received at step S201) for the reserver, and thereafter shifts the processing to step S208.

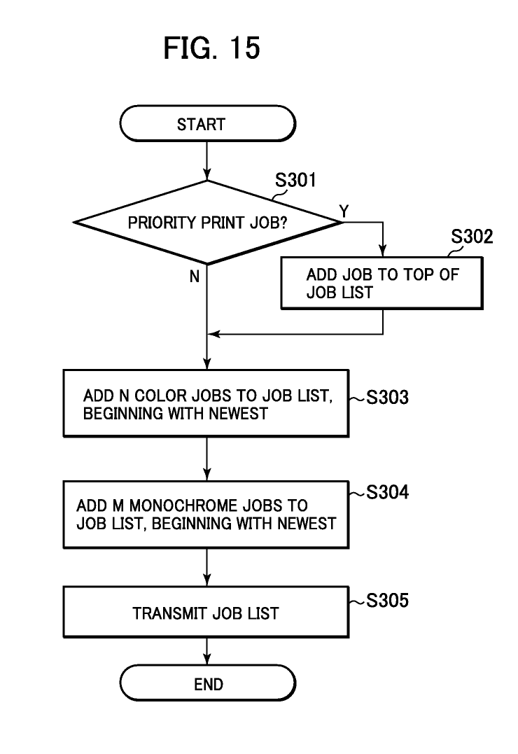

At step S208, in accordance with the user authentication information transmitted at step S207, the controller 103b receives from the server 102 a reserver job list that matches a condition according to which a preprocess is to be performed. The process performed by the server 102 at this time will be described later while referring to FIG. 15.

At step S209, the controller 103b determines whether a job for which the preprocess has not yet been performed is included on the job list received at step S208. When the controller 103b determines that a job for which the preprocess has not yet been performed is included in the job list received at step S208, the controller 103b terminates the processing.

When, at step S209, the controller 103b determines that a job for which the preprocess has not yet been performed is included in the job list received at step S208, the controller 103b advances the processing to step S210.

At step S210, the controller 103b transmits to the server 102 device information, such as information pertaining to either a color printer or a monochrome printer, and a model name, for the image forming apparatus 103 that is used to prepare PDL data.

At step S211, the controller 103b waits until the server 102 prepares PDL data. When PDL data has been prepared by the server 102, at step S212, the controller 103b downloads the PDL data from the server 102 and stores it in the print job holding unit 103d.

At step S213, the controller 103b permits the raster image developing unit 103f to perform raster image developing for the PDL data that was downloaded from the server 102 and is stored in the print job holding unit 103d. The controller 103b then stores the obtained raster image data in the raster image holding unit 103h, and thereafter, returns the processing to step S209. In this manner, the controller 103b repeats the processing from steps S210 to S213 until the preprocess has been completed for all the jobs on the job list.

It should be noted, however, that the controller 103b terminates this reservation processing when a reserver enters a print instruction for the print process at step S111 in FIG. 13 that is performed in a multiprocessing manner parallel to the reservation process, or when a reserver ends a logout process.

FIG. 15 is a flowchart showing example first control processing performed by the server 102 according to an embodiment of the present invention. This processing corresponds to the process for selecting a job for which the server 102 performs a pull print preprocess while process steps S207 and S208 in FIG. 14 are performed. The processing in this flowchart is to be performed by the controller 102b, which is provided when the CPU of the server 102 reads, to the RAM, a program stored on a HDD or another storage medium, and executes the program. It should be noted that S501 to S505 in FIG. 15 indicate individual steps. Further, the processing in this flowchart is to be performed based on the selection condition shown in FIG. 7A for a job for which the preprocess is to be performed.

When the controller 102b receives authentication information for a reserver from the image forming apparatus 103, the controller 102b starts the processing in this flowchart. First, at step S301, the controller 102b determines whether a job for which priority printing is designated is present in the reserved print jobs 102d stored in the print job storage unit 102c.

When, at step S301, the controller 102b determines that there is a job for which priority printing is designated, the controller 102b advances the processing to step S302. At step S302, the controller 102b adds the priority printing designated job to the top of a job list (stored in the RAM (not shown)) and advances the processing to step S303.

When, at step S301, the controller 102b determines that there is no a job for which priority printing is designated, the controller 102b advances the processing to step S303.

At step S303, of the reserved print jobs 102d stored in the print job storage unit 102c, the controller 102b adds N color print jobs (N=2 in this embodiment) to the end of the job list, beginning with the job registered latest.

At step S304, of the reserved print jobs 102d stored in the print job storage unit 102c, the controller 102b adds M monochrome print jobs (M=1) to the end of the job list, beginning with the job registered latest.

At step S305, the controller 102b transmits the job list to the image forming apparatus 103, and thereafter terminates the processing.

FIG. 16 is a flowchart showing example third control processing performed by the image forming apparatus 103 according to an embodiment of the present invention. This processing corresponds to the normal pull printing processing at step S106 in FIG. 13. The processing in this flowchart is to be performed by the controller 103b that is provided when the CPU of the image forming apparatus 103 reads, to the RAM, a program stored on an HDD or another storage medium, and executes the program. It should be noted that S401 to S412 in FIG. 16 indicate individual steps.

First, at step S401, the controller 103b receives user authentication information and the password for a current user that has been entered, using the user authentication screen in FIG. 4, by employing the IC card reader 103k, and thereafter, advances the processing to step S402.

At step S402, the controller 103b performs the user authentication process based on the user authentication information and the password received at step S401, and determines whether the user authentication is has been successful. When the controller 103b determines that the user authentication has not been successful, the controller 103b returns the processing to step S401, and waits for the re-entry of user authentication information and a password.

When, at step S402, the controller 103b determines that the user authentication has been successful, the controller 103b advances to step S403.

At step S403, the controller 103b performs an exclusive login process. That is, the controller 103b inhibits the logging in by another user until the current user logs out.

At step S404, the controller 103b transmits to the serer 102 the authentication information for the user who has logged in, receives from the server 102 a list of print jobs that the current user (the log-in user) can print, and displays the list on the touch panel 401.

At step S405, the controller 103b waits until the current user enters a print job selection instruction based on the print job list that is displayed, and when the print job selection instruction is entered, receives this instruction.

At step S406, the controller 103b transmits to the server 102 information for a job that is selected at step S405, and device information, such as information concerning a color printer or a monochrome printer, and a model name, for the image forming apparatus 103 that is used to prepare PDL data.

At step S407, the controller 103b waits until the server 102 has prepared PDL data. When PDL data has been prepared by the server 102, at step S408, the controller 103b downloads the PDL data from the server 102, and stores it with the PDL data in the print job holding unit 103d.

At step S409, the controller 103b permits the raster image developing unit 103f to perform raster image developing for the PDL data that was downloaded from the server 102 and is stored in the print job holding unit 103d. Further, at step S410, the controller 103b permits the image forming unit 103c to initiate the printing process.

After printing has been performed and a logout instruction is received from the current user, at step S411, the controller 103b performs the logout process, and at step S412, deletes the PDL data (print job) stored in the print job holding unit 103d. The controller 103b thereafter terminates the processing.

FIG. 17 is a flowchart showing fourth control processing performed by the image forming apparatus 103 according to an embodiment of the present invention. This processing corresponds to the pull printing process for the reserver at step S111 in FIG. 13. The processing in this flowchart is to be performed by the controller 103b that is provided when the CPU of the image forming apparatus 103 reads, to the RAM, a program stored on an HDD or another storage medium, and executes the program. It should be noted that S501 to S518 in FIG. 17 indicate individual steps.

First, at step S501, the controller 103b receives user authentication information and a password for a current user that are entered at the user authentication screen in FIG. 9 and by using the IC card reader 103k, and then advances the processing to step S502.

At step S502, the controller 103b performs the user authentication process based on the user authentication information and the password received at step S501, and determines whether the user authentication has been successful. When the controller 103b determines that the user authentication has not been successful, the controller 103b returns the processing to step S501 and waits for the re-entry of the user authentication information and a password.

When, at step S502, the controller 103 determines that the user authentication has been successful, based on the user authentication information and the password received at step S501, at step S503, the controller 103b performs an exclusive login process.

At step S504, the controller 103b transmits the authentication information for the log-in user to the server 102, and receives from the server 102 the list of print jobs that the current user (log-in user) can print. Further, based on the received job list, the controller 103b displays the job list screen in FIG. 11 on the touch panel 401.

At step S505, the controller 103b waits until the current user has entered a print job selection instruction on the job list screen, and when the print job selection instruction has been entered, accepts this print job selection instruction.

At step S506, the controller 103b determines whether all the print jobs designated at step S505 have been printed. When the controller 103b determines that the printing has not yet been completed, the controller 103 advances the processing to step S507.

At step S507, the controller 103b determines whether a job for which raster data developing has been performed is included in the print jobs selected at step S505. When the controller 103b determines that there is a job for which raster data has been developed, at step S508, the controller 103b permits the image forming unit 103c to initiate the printing only of the job for which raster data has been developed, and thereafter, returns the processing to step S506. Then, the process at step S506 and the following processes are performed parallel to the printing process at step S508.

When, at step S508, the controller 103b determines that a job for which raster data have been developed is not present in the print jobs selected at step S505, the controller 103b advances the processing to step S509.

At step S509, the controller 103b determines whether a job that has been downloaded is present in the printed jobs selected at step S505. When the controller 103b determines that there is a job that has been downloaded, the controller 103b advances the processing to step S510.

At step S510, the controller 103b permits the raster image developing unit 103f to develop only the downloaded job to obtain raster image data. Then, at step S511, the controller 103b permits the image forming unit 103c to begin printing the obtained raster image data, and thereafter, returns the processing to step S506. Thereafter, the process at step S506 and the following processes are performed parallel to the printing process at step S511.

When, at step S509, the controller 103b determines that a downloaded job is not present in the printed jobs selected at step S505, the controller 103b advances the processing to step S512.

At step S512, the controller 103b transmits to the server 102 device information, such as information for a color printer or a monochrome printer and a model name, for the image forming apparatus 103 that is used to prepare PDL data.

At step S513, the controller 103b waits until the server 102 has prepared PDL data. When PDL data has been prepared by the server 102, at step S514, the controller 103b downloads the PDL data from the server 102, and stores it in the print job holding unit 103d.

At step S515, the controller 103b permits the raster image developing unit 103f to perform raster image data developing for the PDL data that was downloaded from the server 102 and is stored in the print job holding unit 103d. Further, at step S516, the controller 103b permits the image forming unit 103c to initiate the printing of the obtained raster image data, and then returns the processing to step S506. Thereafter, the processing at step S506 and the following process are performed parallel to the printing process at step S516.

The controller 103b repeats these processes until the printing of all the print jobs selected at step S505 has been completed.

Furthermore, when, at step S506, the controller 103b determines that all the print jobs selected at step S505 have been printed, the controller 103b advances the processing to step S517. At step S517, the controller 103b performs a logout process, and at step S518, deletes the PDL data (job) from the print job holding unit 103d. Thereafter, the controller 103b terminates the processing.

As described above, according to this embodiment, when the preceding user is currently employing the image forming apparatus 103, another user can enter a pull print reservation at the image forming apparatus 103, and need not wait near the apparatus until the operation being performed by the preceding user has ended.

Further, in this embodiment, the print jobs for a reserver are downloaded, PDL is developed and raster data are developed in advance, parallel to the operation being performed by the preceding user. Therefore, when the operation performed by the preceding user has been ended, and the user authentication for the reserver has been accepted, the reserver can start a printing operation immediately. As a result, the waiting period to perform printing is shorter than it is for normal pull printing.

### Second Exemplary Embodiment

A second exemplary embodiment of the present invention will now be described.

According to the second embodiment, a job registration process and a pull print preprocess are performed in the same manner as in the first embodiment. In the arrangement of the second embodiment, when an operating unit is available but the printing of a pull print job for a user is not currently permitted, the user is allowed to enter a pull print reservation. A case wherein the printing of a pull print job for a user is not currently permitted can include, for example, a case wherein an image forming unit is currently being employed by another user, or a case wherein an image forming unit is in an error state, such as having run out of paper or ink.

This arrangement is provided in order to resolve the following problems.

Assume that, since how soon the current user will finish the print job is unknown, for the print job the next user wants to perform, the user uses an automatic printing setting so that performance of the job will begin as soon as the job being performed for the current user has been completed. In this case, the next user does not known when the printing will begin, and should the user be absent when printing starts, printed matter would be unprotected. This could constitute or develop into a security problem.

Further, assume that in a paper exhausted state, automatic printing has been set by a user. In this case, while the user is absent obtaining paper, paper could be supplied by another user, and this user could see or obtain copies of the printing results. This could also constitute or develop into a security problem.

In that a reserver can employ the operating unit 103g of the image forming apparatus 103 at the time a reservation is made, a pull print reservation for the second embodiment differs from one for the first embodiment. In this embodiment, since the operating unit 103g of the image forming apparatus 103 can be used at the time a reservation is made, a reserver can designate a print job for which a preprocess is to be performed. Further, after the printing for a preceding user has been completed, or after an error state has been corrected, an email (FIG. 8) indicating that printing is available is transmitted to the reserver. Furthermore, only print jobs selected by the reserver when making reservations are shown in the print job list display portion 1101, on the job selection screen (FIG. 11) displayed after re-authentication of the reserver has been successfully concluded.

Further, in the first embodiment, for downloading a print job from the server 102 to the image forming apparatus 103, the server 102 converts a PDF file into PDL data, while the image forming apparatus 103 performs raster image developing for the PDL data. However, in this embodiment, the server 102 transmits a PDF file unchanged to the image forming apparatus 103, and the image forming apparatus 103 performs raster image developing directly for the PDF file.

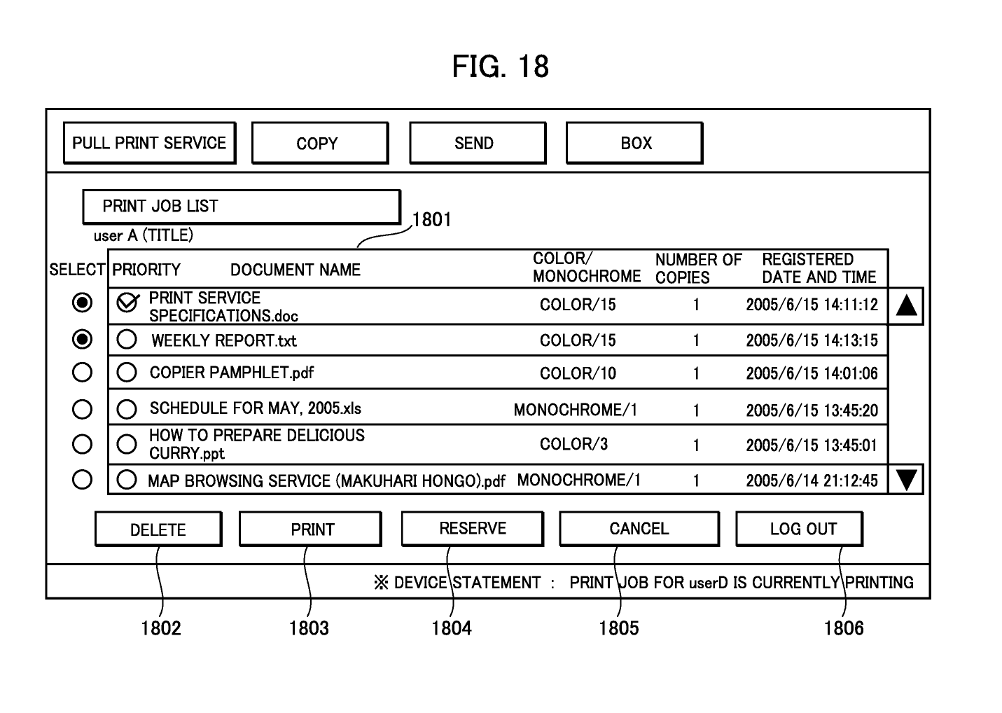

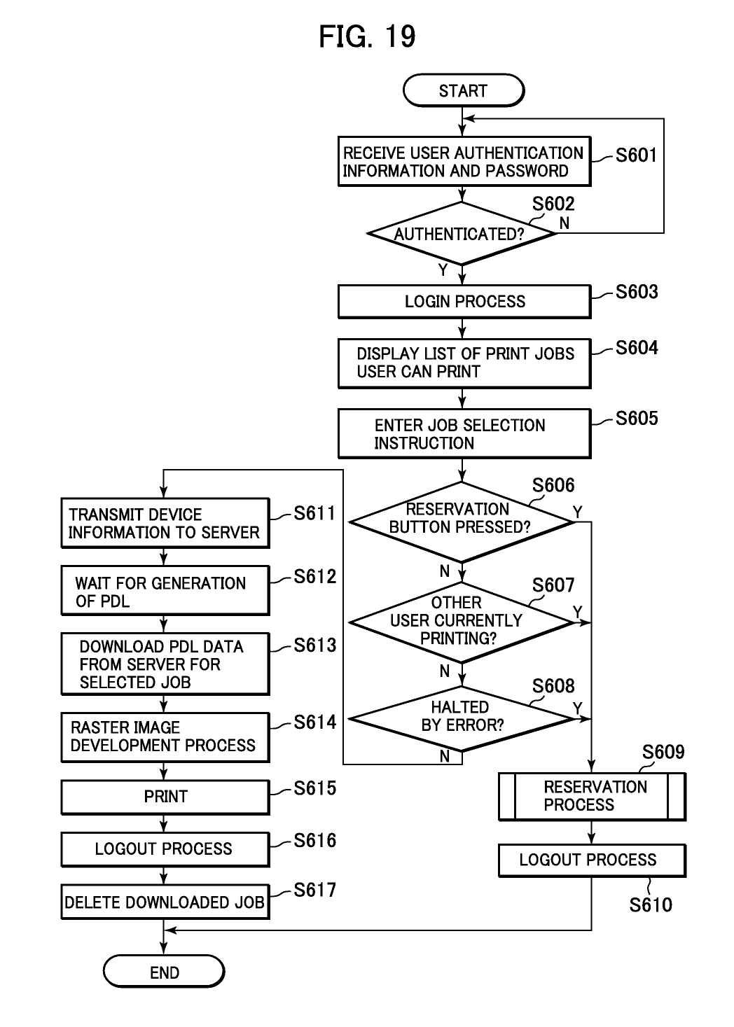

The arrangement for the second embodiment will now be described while referring to FIGS. 18 and 19.

FIG. 18 is a diagram showing a screen to be displayed on the touch panel of the image forming apparatus 103 after user authentication for the reserver is accepted by the image forming apparatus 103. On this screen, the reserver selects a job to be preprocessed, and makes a reservation.

In FIG. 18, a print job list display portion 1801 is used to display a list of jobs for a reserver held in the server 102. This print job list display unit 1801 is the same as the job selection screen (FIG. 11) in the first embodiment that is displayed after the re-authentication for the reserver is successful. It should be noted that, since the preprocess is not performed for the print job selection screen (FIG. 18) at the reservation time, the preprocess state is not displayed.

The user can select a print job by touching a job displayed on the print job list display portion 1801.

A delete button 1802 is used to delete a selected job from the server 102. A print button 1803 is used to instruct immediate printing. When another user is currently printing or printing is disabled because of no paper, by pressing the print button 1803, the same process as when a reserve button 1804 is pressed is performed.

The reserve button 1804 is used to establish the selected job as a preprocess target job, and to make the same pull print reservation as that for the first embodiment.

For example, when a user has made a reservation while the preceding user is printing a large volume, the user need not wait in front of the image forming apparatus 103 until the preceding user finishes printing. After the reservation is accepted, the user temporarily logs out, and then when the preceding user completes printing or when the error state is removed, logs in again, and performs the pull print process for the reserver shown in FIG. 17.

A cancel button 1805 is used to cancel selection of a print job. A log out button 1806 is used to instruct logging out of the image forming apparatus 103.

FIG. 19 is a flowchart showing fifth control processing performed by the image forming apparatus 103 of the invention. This processing corresponds to the reservation processing for the image forming apparatus 103 according to the second embodiment. The processing in this flowchart is to be performed by the controller 103b that is provided when the CPU of the image forming apparatus 103 reads, to the RAM, a program stored on the HDD or another storage program, and executes this program. It should be noted that S601 to S617 in FIG. 19 indicate individual steps.

First, the processes at steps S601 to S605 are the same as those at steps S501 to S505 in the pull print process for the reserver in FIG. 17.

That is, at step S601, the controller 103b receives user authentication information and a password for a current user that are entered on the user authentication screen in FIG. 9 and by using the IC card reader 103k, and advances the processing to step S602.

At step S602, the controller 103b performs the user authentication process based on the user authentication information and the password received at step S601, and determines whether user authentication is successful. When the controller 103b determines that user authentication is not successful, the controller 103b returns the processing to step S601, and waits for re-entry of user authentication information and a password.

When, at step S602, the controller 103b determines that user authentication is successful based on the user authentication information and the password received at step S601, at step S603, the controller 103b performs the exclusive login process.

At step S604, the controller 103b transmits the authentication information for the log-in user to the server 102, and receives, from the server 102, a list of print jobs that the current user (log-in user) that can print. Further, based on the received job list, the controller 103b displays the print job list screen in FIG. 18 on the touch panel 401.

At step S605, the controller 103b waits until the current user enters a print job selection instruction on the print job list screen, and when the print job selection instruction is entered, accepts this instruction.

After the print job is selected, at step S606, the controller 103b determines whether the reserve button 1804 is pressed. When the reserve button 1804 is pressed, the controller 103b advances the processing to step S609.

At step S609, the controller 103b performs the processes at steps S209 to S213 in the reservation processing in FIG. 14, and at step S610, performs the logout process. Thereafter, the controller 103b terminates the processing.

On the other hand, when, at step S606, the controller 103b determines that the reserve button 1804 is not pressed, the controller 103b advances the processing to step S607.

At step S607, the controller 103b determines whether another user is currently printing. When the controller 103b determines that another user is currently printing, the controller 103b advances the processing to step S609.

When, at step S607, the controller 103b determines that no user is printing, the controller 103b advances the processing to step S608.

At step S608, the controller 103b determines whether the image forming apparatus 103 is halted because of an image forming error, such as out of consumables like out of paper, toner exhaust or paper jam. When the controller 103b determines that the image forming apparatus is halted due to an error, the controller 103b advances the processing to step S609.

When, at step S608, the controller 103b determines that the image forming apparatus 103 is not halted due to an image forming error, such as out of consumables like out of paper, toner exhaust or paper jam, the controller 103b advances the processing to step S611.

The processes at step S611 to S617 are the same as those in the normal pull printing process in FIG. 16.

That is, at step S611, the controller 103b transmits, to the server 102, information for the job selected at step S605 and device information (information as to a color printer or a monochrome printer and a model name) of the image forming apparatus 103 that is used to prepare PDL data.

At step S612, the controller 103b waits until the server 102 prepares PDL data. When PDL data is prepared by the server 102, at step S613, the controller 103b downloads the PDL data from the server 102, and stores the PDL data in the print job holding unit 103d.

At step S614, the controller 103b permits the raster image developing unit 103f to perform raster image developing for the PDL data that was downloaded from the server 102 and is stored in the print job holding unit 103d. Further, at step S615, the controller 103b permits the image forming unit 103c to print the obtained raster image data.

After printing is completed and a logout instruction is received from the current user, at step S616, the controller 103b performs the logout process, and at step S617, deletes the PDL data (print job) from the print job holding unit 103d. Thereafter, the controller 103b terminates the processing.

In this embodiment, the print button 1803 and the reserve button 1804 have been provided. However, in an another embodiment, only a reserve button may be provided.

As described above, according to this embodiment, when the operating unit is available but printing of a pull print job for a user is not currently permitted (because, for example, the preceding user is currently printing or the image forming apparatus is halted due to an error), the user can make a pull print reservation for the image forming apparatus. Therefore, the user need not wait in front of the apparatus until printing is available.

Further, while the printing process is being performed by the preceding user, or while the system is halted due to an error, such as shortage of a durability, the print job selected by the reserver in advance is downloaded, PDL developed and raster developed. According to this arrangement, when the printing process for the preceding user is ended, or the error is removed, and when user authentication for the reserver is accepted, the actual printing process can be immediately started. As a result, the print waiting period can be reduced compared with for the conventional pull print process.

### Third Exemplary Embodiment

In a third embodiment of the present invention, the WEB browser of the client PC 101 accesses the image forming apparatus 103 via the network 105 to examine the state of the image forming apparatus 103. When the image forming apparatus 103 is currently used by the preceding user, the WEB browser may transmit user authentication information, such as a user ID and a password, to the image forming apparatus 103 to make a reservation for the succeeding pull printing. In this reservation process, the WEB browser may display a list of jobs for a reserver stored in the server 102, so that, on the print job list screen shown in FIG. 18, the reserver can select a job for pull printing to make a reservation.

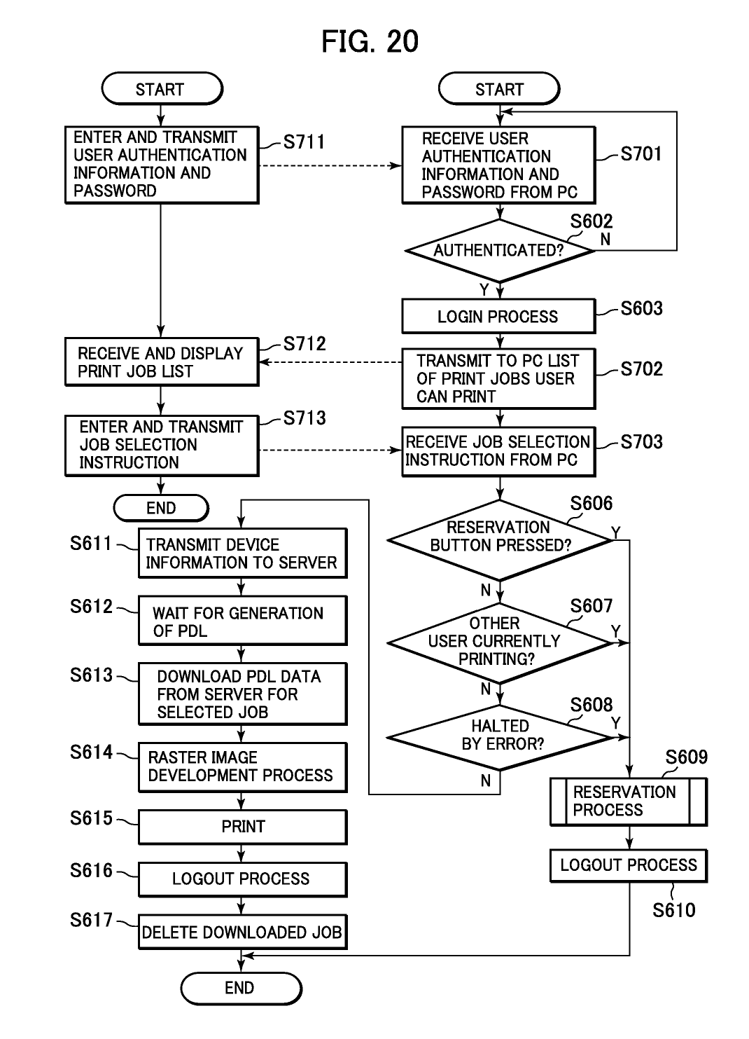

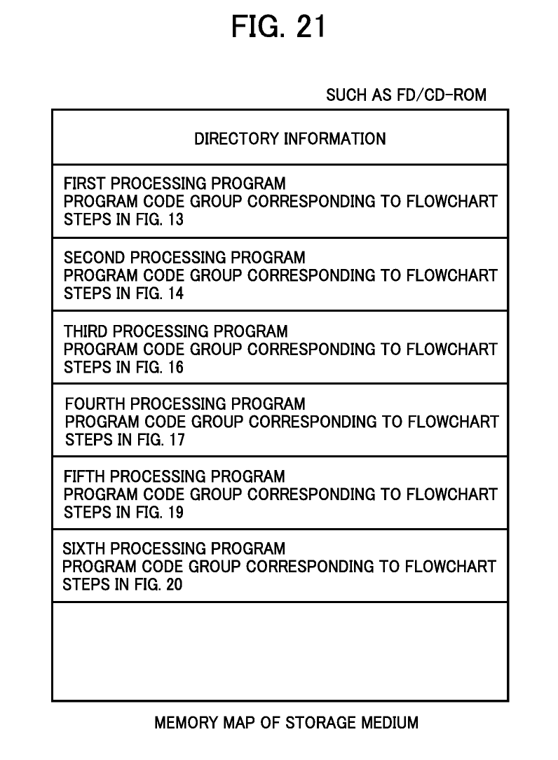

FIG. 20 is a flowchart showing sixth control processing performed by the image forming apparatus of the present invention. This processing corresponds to the reservation processing performed by the image forming apparatus 103 for the third embodiment. The processes at steps S602, S603, S606 to S617 and S701 to S703 correspond to the processes performed by the image forming apparatus 103. This processing is performed by the controller 103b that is provided when the CPU of the image forming apparatus 103 reads, to the RAM, a program stored on the HDD or another storage medium, and executes this program. Further, the processes at step S711 to S713 in the flowchart correspond to those performed by the client PC 101. To perform this processing, the WEB browser accesses the image forming apparatus 103, and downloads and displays the contents under the control of the controller 101b. It should be noted that the controller 101b is provided when the CPU of the client PC 101 reads, to the RAM, a program stored on the HDD or another storage medium, and executes this program. In this flowchart, the same step numbers as used in FIG. 19 are provided for corresponding steps.

First, the WEB browser, operated by the controller 101b of the client PC 101, accesses the image forming apparatus 103 via the network 105. Then, the WEB browser obtains a login screen from the image forming apparatus 103, and displays the screen on the monitor to accept user authentication information and a password from a current user entered through, for example, a keyboard.

At step S711, the WEB browser of the controller 101b transmits, to the image forming apparatus 103, the user authentication information and the password for the current user that are entered through, for example, the keyboard.

At step S701, the controller 103b of the image forming apparatus 103 receives from the client PC 101 the user authentication information and the password for the current user, and advances the processing to step S602.

When, at step S602, the controller 103b determines that user authentication is successful based on the user authentication information and the password received at step S701, at step S603, the controller 103b performs the exclusive login process.

At step S702, the controller 103b transmits the authentication information for the log-in user to the server 102, and receives, from the server 102, a list of print jobs that the current user (log-in user) can print. Further, based on the received job list, the controller 103b transmits the print job list screen (FIG. 18) to the client PC 101.

On the client PC 101 side, at step S712, the WEB browser operated by the controller 101b displays, on the monitor of the client PC 101, the print job list screen (FIG. 18) received from the image forming apparatus 103.

At step S713, the WEB browser operated by the controller 101b waits until the current user enters a print job selection instruction on the print job list screen. When the print job selection instruction is entered, the WEB browser of the controller 101b transmits the print job selection instruction to the image forming apparatus 103

On the image forming apparatus 103 side, at step S703, the controller 103b receives the print job selection instruction from the client PC 101, and advances the processing to step S606. Since the process at step S606 and the following process are the same as those in FIG. 19, no further explanation for them will be given.

As described above, regardless of whether the operating unit 103g of the image forming apparatus 103 is available or not, when a user is not currently permitted to print user's pull print job, the user can employ the client PC 101 to make a pull print reservation for the image forming apparatus 103. Therefore, the user need not wait in front of the apparatus until printing is available.

Further, as well as in the above embodiments, in parallel to the printing operation of the preceding user, various preprocesses are performed in consonance with the reserved print jobs. Thus, after user authentication is accepted for a reserver, the actual printing process can be started. As a result, the print waiting period can be reduced compared with for the normal pull printing.

In this embodiment, the image forming apparatus 103 has been accessed by the WEB browser that is operated by the controller 101b of the client PC 101. However, a special program executed by the controller 101b of the client PC 101 may be employed to access the image forming apparatus 103.

Further, in the above individual embodiments, a print job has been registered with the server 102 by the client PC 101. However, a print job may be directly registered with the image forming apparatus 103 by the client PC 101.

Furthermore, only print job information shown in FIG. 3 may be registered by the client PC 101 with the server 102 or the image forming apparatus 103, and a print job (print data) may be held in the client PC 101. In this case, when a pull print reservation is made, the image forming apparatus 103 downloads print information consonant with the reservation from the client PC 101, in parallel to the image forming process performed by the preceding user.

In the description of the above embodiments, a pull print reservation is made in the immediate printing disabled state of the image forming apparatus wherein image forming can not be immediately performed for a new print job. However, regardless of the state of the image forming apparatus, reserving of pull printing may be enabled at an arbitrary timing. In this case, when user authentication information is entered by the IC card reader 103k at an arbitrary timing, the controller 103b reserves a pull print process for the user that is authenticated based on the user authentication information. Then, of pull print processes for print jobs that are identified based on the user authentication information for the reserving user and that are registered in the server 102, the controller 103b performs a preprocess that does not accompany image forming. Furthermore, at an arbitrary timing asynchronous with the preprocess, the controller 103b permits reentry, on the operating unit 103g, of the user authentication information to authenticate the reserving user. Additionally, beginning with the remaining process after the preprocess is completed, the controller 103b performs the pull print process of the print jobs identified based on the user authentication information that is re-entered. According to this arrangement, regardless of the state of the image forming apparatus, the user can make a reservation at a pull print reservation timing and perform the preprocess. As a result, this is effective for a case wherein the user desires to prepare for the job though printing is not immediately requested. And when a print instruction is entered, a print job that has been preprocessed can be rapidly output.

The structure of various data in FIGS. 3, 6 and 7 and the contents of these data are not limited to those described, and the data can employ various structures and various contents in accordance with specific usages and purposes.

The embodiments of the invention have been explained, and the present invention can also be provided as a system, an apparatus, a method, a program or a recording medium. Specifically, the present invention can be applied for a system constituted by a plurality of apparatuses, or for an apparatus that includes only one device.

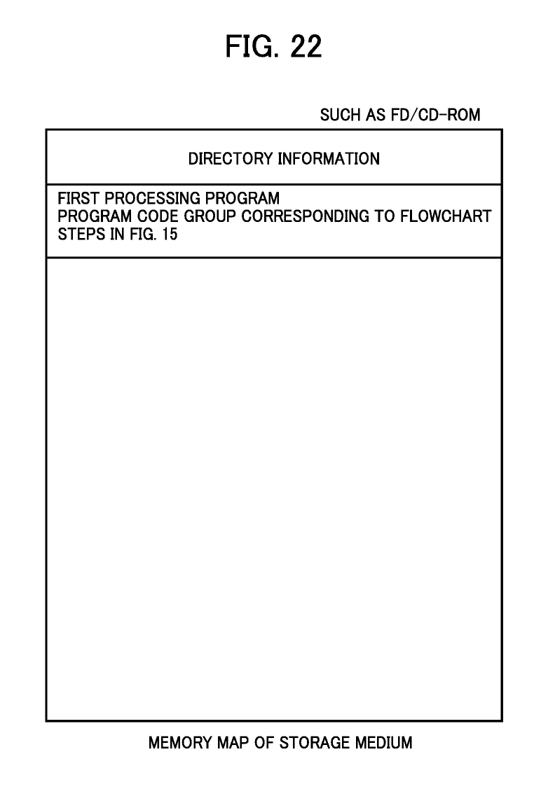

Next, while referring to a memory map shown in FIGS. 21 and 22, an explanation will be given for the structure of the memory map of a storage medium on which recorded are various data processing programs readable by the image forming apparatus and the server of the present invention.

FIG. 21 is a diagram for explaining the memory map of a storage medium (recording medium) on which are stored various data processing programs readable by the image forming apparatus of the present invention.

FIG. 22 is a diagram for explaining the memory map of a storage medium (recording medium) on which are stored various data processing programs readable by the server of the present invention.

Although not specifically shown, information, such as version information and a creator's name, for managing program groups stored on the storage medium is also stored. Further, information that depends on the OS on a program reading side, e.g., an icon used to identify a program on a display, may also be stored.

In addition, subject data for various programs are also stored in directory information. A program for installing various programs in a computer, or a program for decompressing a compressed program to be installed, may also be stored.

The functions shown in FIGS. 13, 14, 15, 16, 17, 19 and 20 for the embodiments may be performed by a host computer using programs that are externally installed. Embodiments of the present invention can also be applied for a case wherein information groups including a program are supplied to an output device by means of a storage medium, such as a CD-ROM, a flash memory or an FD, or by means of an external storage medium via a network.

To achieve the features of embodiments of the invention, in the above described manner, the storage medium on which software program code that provides the function of the above embodiments is supplied to a system or to an apparatus. Then, when the computer (a CPU or an MPU) of the system or the apparatus reads and executes program code stored on a storage medium.

In this case, the program code read from the storage medium constitutes the novel function of the invention, and the storage medium on which the program code is stored constitutes the present invention.

Therefore, so long as the function of the program is included, an arbitrary program form can be employed, for example, for object code, a program executed by an interpreter or script data supplied to the OS.

An example storage medium for supplying a program can be a flexible disk, a hard disk, an optical disk, a magneto-optical disk, a CD-ROM, a CD-R, a CD-RW, a magnetic tape, a nonvolatile memory card, a ROM or a DVD.

In this case, the program code read from a storage medium provides the functions of the above embodiments, and the storage medium on which the program code is stored constitutes the present invention.

Another program supply method is as follows. An internet homepage is accessed using the browser of a client computer, and a computer program for the present invention, or a compressed file that includes an automatic installation function is downloaded from the homepage and is supplied, in this manner, to a storage medium, such as a hard disk. As another method, program code that constitute a program for this invention are divided into a plurality of files, and by downloading these files from different homepages, the program can also supplied. That is, a WWW server or a ftp server, from which a plurality of users can download a program file that permits a computer to perform the function of the present invention, are also included in the claims of the present invention.

Further, as another method, the program of the invention is encrypted and the encrypted program is stored on storage media, such as CD-ROMs, which are distributed to users. Thereafter, a user who satisfies a predetermined condition is permitted to download, from the homepage via the Internet, key information for decrypting the program. Then, by using the key information, the user executes the encrypted program to install it on the computer.

Furthermore, the present invention includes not only the case where in the functions of the embodiments are provided by executing the program code read by the computer, but also includes a case wherein, for example, based on an instruction in the program code, the OS (Operating System) running on a computer performs part, or all of the actual processing, and through this processing, provides all the functions of the embodiments.

In addition, the present invention also includes the following case. Program code read from a storage medium is written into a memory prepared for a function extension board inserted into a computer, or a function extension unit connected to the computer. In accordance with instructions included in the program code, the CPU provided for the function extension board or the function extension unit performs part or all of the actual processing, and through this processing, provides all the functions of the embodiments.

The present invention may be applied for a system constituted by a plurality of apparatuses, or an apparatus that includes only one device. Further, the present invention can be applied for a case wherein a program is supplied either to a system or to an apparatus. In this case, when the system or the apparatus reads from a storage medium a software program that achieves the present invention, the system or the apparatus can obtain the effects provided by the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

In addition, embodiments of the present invention are not limited to pull printing, and can also be applied for, for example, an image forming apparatus that forms an image on a recording material based on an input print job. Specifically, while a first user is logged in the image forming apparatus, a controller permit a second user different from the first user to enter user information on an operating unit. Furthermore, of processes associated with the second user for which user information is entered at the operating unit, the controller performs preprocesses that do not accompany image forming during a period in which the first user is logged in the image forming apparatus.

With this arrangement, when a user is employing the image forming apparatus, another user can make a reservation for a process using the image forming apparatus. Further, during the login of the current user, the image forming apparatus performs the preprocess for the predetermined process for the reserving user, so that a waiting period for the reserving user can be reduced.

As described above, according to an embodiment of the pull print system of the present invention, when a user is employing the image forming apparatus, another user can reserve pull printing by user authentication for the image forming apparatus. Additionally, in parallel to the operation of the current user, pull print preprocessing is performed for a specific job for a reserving user, so that the waiting period for pull printing can be reduced.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-297439, filed Oct. 12, 2005, which is hereby incorporated by reference herein in its entirety.

What is claimed is:

1. An image forming apparatus, for forming an image on recording material based on an input print job, comprising:
an input unit adapted to receive user information for a second user while a first user is logged in with the image forming apparatus; and
a processing unit adapted to perform, while the first user is logged in with the image forming apparatus, as a process for a print job related to the second user, whose user information has been received by the input unit, a preprocess that does not accompany image forming.

2. An image forming apparatus according to claim 1, further comprising:
a reserving unit adapted to reserve processes for print jobs related to the second user while the first user is logged in with the image forming apparatus,
wherein the processing unit performs preprocesses, associated with the reserved processes, that do not accompany image forming.

3. An image forming apparatus according to claim 2, wherein, when the login of the first user is released from the image forming apparatus, remaining processes that are reserved by the reserving unit are performed.

4. An image forming apparatus according to claim 3, wherein, after the login of the first user is released by the image forming apparatus, user authentication information associated with the second user is processed in order to authenticate the second user,
wherein, when the second user is authenticated, the remaining processes are performed.

5. An image forming apparatus according to claim 2, wherein, of print jobs identified based on the user information for the second user for whom processing is reserved by the reserving unit, the processing unit performs a preprocess for a print process that matches a predetermined condition.

6. An image forming apparatus according to claim 5, wherein the predetermined condition includes either a condition for selecting a print job registered during a specific period in the past, a condition for selecting a predetermined number of print jobs registered recently, a condition for selecting a print job to which priority information has been added or a condition for selecting a print job that is highly compatible with an image forming capability of the image forming apparatus.

7. An image forming apparatus according to claim 4, further comprising a display to display a list of the print jobs identified based on the user authentication information, wherein the input unit permits selection of a print job to be processed from the list of the print jobs.

8. An image forming apparatus according to claim 7, wherein preprocess states of individual print jobs are indicated on the list of print jobs.

9. An image forming apparatus according to claim 2, wherein the reserving unit enables a plurality of users to reserve processes.

10. An image forming apparatus according to claim 1, wherein the process is a pull print process for downloading a print job registered at a recording location on a network, and for forming an image.

11. An image forming apparatus according to claim 2,
wherein the process is a pull print process for downloading a print job registered with an external device on a network, and
wherein the processing unit downloads a print job registered with the external device that is identified based on the user information for the second user, for whom processing is reserved by the reserving unit.

12. An image forming apparatus according to claim 11,
wherein the external device stores a print job in a general form that does not depend on a special image forming apparatus, employs the print job in the general form that does not depend on the special image forming apparatus to generate data having a form that depends on the image forming apparatus, and transmits the data to the image forming apparatus, and
wherein the processing unit downloads, as data in the form that depends on the image forming apparatus, a print job that is registered with the external device and that is identified based on the user information for the second user, for whom processing is reserved by the reserving unit.

13. An image forming apparatus according to claim 12, wherein the processing unit transmits, to the external device, information for generating data in the form that depends on the image forming apparatus.

14. An image forming apparatus according to claim 12,
wherein the external device stores a print job in a general-purpose form that does not depend on a special image forming apparatus, and
wherein the processing unit downloads, as data in a general-purpose form that does not depend on the image forming apparatus, a print job that is registered with the external device and that is identified based on the user information for the second user, for whom processing is reserved by the reserving unit, and employs the data in the general-purpose form to generate data having a form that depends on the image forming apparatus.

15. An image forming apparatus according to claim 12, wherein the processing unit develops data having a form that depends on the image forming apparatus to obtain raster image data.

16. An image forming apparatus according to claim 2, further comprising:
a notifying unit adapted to transmit, to an address corresponding to the second user, for whom processing is reserved by the reserving unit, a notification indicating that the login of the first user has been released by the image forming apparatus.

17. An image forming apparatus according to claim 4,
wherein the input unit reads user information stored on a storage medium to input user information, and
wherein the input unit and an operating unit of the image forming apparatus are employed to receive user authentication information.

18. An image forming apparatus according to claim 4,
wherein the input unit receives user information from the external device via communication, and
wherein the an operating unit of the image forming apparatus is employed to receive user authentication information.

19. An image forming apparatus according to claim 17, wherein the input unit controls the operating unit so that, during a period after the login of the first user has been released by the image forming apparatus, an entry other than user authentication information, for authenticating the second user, that is reserved by the reserving unit is not accepted.

20. An image forming apparatus according to claim 4, further comprising:
a deleting unit adapted to delete a reservation consonant with the second user and the preprocessed print job for the second user when user authentication information for the second user, whose processing is reserved by the reserving unit, is not received within a predetermined period after the login of the first user has been released by the image forming apparatus; and
a notifying unit adapted to transmit, to the address consonant with the second user, a notification indicating that the reservation of the second user is deleted by the deleting unit.

21. An image forming apparatus according to claim 4,
wherein the input unit permits the second user, whose processing is reserved by the reserving unit, to enter user authentication information and log in at the image forming apparatus, and
wherein, when the second user has logged out of the image forming apparatus, a reservation consonant with the second user and the preprocessed print job consonant with the second user are deleted.

22. An image forming apparatus, which instructs, through an operating unit, pull printing for a print job that is registered at a recording location and performs image forming for the print job for which pull printing is instructed, comprising:
an input unit adapted to receive user information;
a reserving unit adapted to reserve a pull printing process for a user specified by the user information received by the input unit;
a preprocessing unit adapted to perform a preprocess, which does not accompany image forming, for a pull printing process for the print job registered at the recording location, which is specified based on the user information for the user, that is reserved by the reserving unit;
a re-input unit adapted to receive, in asynchronization with the preprocess, entry of user authentication information for authenticating the user, that is reserved by the reserving unit; and
a post-processing unit adapted to perform, beginning with remaining process following the performance of the preprocess by the preprocessing unit, the pull printing process for the print job specified by the user authentication information received by the re-input unit.

23. An image forming apparatus according to claim 22, wherein the input unit reads user information stored on a storage medium to input user information.

24. A method comprising:
receiving user information for a second user, who is different from a first user, while the first user is logged in with an image forming apparatus; and
performing, while the first user is logged in with the image forming apparatus, a process that does not accompany image forming for a print job related to the second user, whose user information has been received.

25. A computer-readable medium storing instructions which, when executed by an image forming apparatus, which forms an image on recording material based on an input print job, causes the image forming apparatus to perform operations comprising:
receiving user information for a second user, who is different from a first user, while the first user is logged in with the image forming apparatus; and
performing, while the first user is logged in with the image forming apparatus, a process that does not accompany image forming for a print job related to the second user, whose user information has been received.
